(19) United States
(12) Patent Application Publication
(10) Pub. No.: US 2024/0089763 A1
(43) Pub. Date: Mar. 14, 2024

(54) TIMING ADVANCING FOR BIDIRECTIONAL FULL-DUPLEX SIDELINK COMMUNICATION

(71) Applicant: QUALCOMM Incorporated, San Diego, CA (US)

(72) Inventors: Shuanshuan WU, San Diego, CA (US); Kapil GULATI, Belle Mead, NJ (US); Junyi LI, Fairless Hills, PA (US); Anantharaman BALASUBRAMANIAN, San Diego, CA (US); Sourjya DUTTA, San Diego, CA (US); Hui GUO, Beijing (CN); Navid ABEDINI, Basking Ridge, NJ (US)

(21) Appl. No.: 18/272,789

(22) PCT Filed: Mar. 31, 2021
(86) PCT No.: PCT/CN2021/084683

§ 371 Date: Jul. 17, 2023

(51) Int. Cl. H04W 24/08; H04L 5/16; H04W 56/00

(52) U.S. Cl. CPC H04W 24/08; H04L 5/16; H04W 56/0045

(57) ABSTRACT

Apparatus, methods, and computer-readable media for facilitating timing advancing for bidirectional full-duplex sidelink communication are disclosed herein. An example method for wireless communication at a first UE includes performing a self-interference measurement on a unicast link with a second UE to determine a link quality. The example method also includes applying a TA adjustment for transmission or reception with the second UE based on the self-interference measurement.

### INTRODUCTION

The present disclosure relates generally to communication systems, and more particularly, to sidelink communication.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of wireless communication may comprise direct communication between devices based on sidelink, such as in vehicle-to-everything (V2X) and/or other device-to-device (D2D) communication. There exists a need for further improvements in sidelink technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, an apparatus for wireless communication at first user equipment (UE) is provided. The apparatus includes memory and at least one processor coupled to the memory. The memory and the at least one processor are configured to perform a self-interference measurement on a unicast link with a second UE to determine a link quality. The memory and the at least one processor are also configured to apply a timing advance (TA) adjustment for transmission or reception with the second UE based on the self-interference measurement.

In another aspect of the disclosure, a method is provided for wireless communication at a first UE. The method includes performing a self-interference measurement on a unicast link with a second UE to determine a link quality. The example method also includes applying a TA adjustment for transmission or reception with the second UE based on the self-interference measurement.

In another aspect of the disclosure, an apparatus for wireless communication at a first UE is provided. The apparatus includes means for performing a self-interference measurement on a unicast link with a second UE to determine a link quality. The example apparatus also includes means for applying a TA adjustment for transmission or reception with the second UE based on the self-interference measurement.

In another aspect of the disclosure, a computer-readable medium storing computer executable code for wireless communication at a first UE is provided. The code, when executed, causes a processor to perform a self-interference measurement on a unicast link with a second UE to determine a link quality. The code, when executed, causes the processor to also apply a TA adjustment for transmission or reception with the second UE based on the self-interference measurement

In another aspect of the disclosure, an apparatus for wireless communication with a first UE at a second UE is provided. The apparatus includes memory and at least one processor coupled to the memory. The memory and the at least one processor are configured to transmit and receive sidelink communication with the first UE in a full-duplex mode on a unicast link. The memory and the at least one processor are also configured to apply a TA adjustment for transmission or reception of the sidelink communication with the first UE, the TA adjustment being based on interference at the first UE or the second UE.

In another aspect of the disclosure, a method is provided for wireless communication with a first UE at a second UE. The method includes transmitting and receiving sidelink communication with the first UE in a full-duplex mode on a unicast link. The example method also includes applying a TA adjustment for transmission or reception of the sidelink communication with the first UE, the TA adjustment being based on interference at the first UE or the second UE.

In another aspect of the disclosure, an apparatus for wireless communication with a first UE at a second UE is provided. The apparatus includes means for transmitting and receiving sidelink communication with the first UE in a full-duplex mode on a unicast link. The example apparatus also includes means for applying a TA adjustment for transmission or reception of the sidelink communication with the first UE, the TA adjustment being based on interference at the first UE or the second UE.

In another aspect of the disclosure, a computer-readable medium storing computer executable code for wireless communication with a first UE at a second UE is provided. The code, when executed, causes a processor to transmit and receive sidelink communication with the first UE in a full-duplex mode on a unicast link. The code, when executed, causes the processor to also apply a TA adjustment for transmission or reception of the sidelink communication with the first UE, the TA adjustment being based on interference at the first UE or the second UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network including sidelink communication.

FIG. 2 illustrates example aspects of a sidelink slot structure.

FIG. 3 is a diagram illustrating an example of a first device and a second device involved in wireless communication based, for example, on sidelink.

FIG. 4A is a diagram illustrating examples of wireless devices having multiple transmitter-receiver points (TRPs), in accordance with the teachings disclosed herein.

FIG. 4B is a diagram illustrating the common processing and the separating processing for multiple TRPs of a wireless device, in accordance with the teachings disclosed herein.

FIG. 5 illustrates an example of a sensing and reservation procedure for sidelink resource communication, in accordance with the teachings disclosed herein.

FIG. 6 illustrates examples of in-band full-duplex (IBFD) resources and sub-band frequency division duplex (FDD) resources for full-duplex communication, in accordance with the teachings disclosed herein.

FIG. 7A illustrates an example of full-duplex communication, in accordance with the teachings disclosed herein.

FIG. 7B illustrates an example of bidirectional full-duplex communication, in accordance with the teachings disclosed herein.

FIG. 8A illustrates an example timing diagram for a transport block with respect to a transmitting UE and a receiving UE, in accordance with the teachings disclosed herein.

FIG. 8B is a diagram with a first node communicating with a first UE and a second UE, in accordance with the teachings disclosed herein.

FIG. 8C illustrates a timing diagram of non-bidirectional full-duplex sidelink communication with respect to a desired signal and a reflected signal, in accordance with the teachings disclosed herein.

FIG. 8D illustrates a timing diagram of non-bidirectional full-duplex sidelink communication including timing adjustment with respect to a desired signal and a reflected signal, in accordance with the teachings disclosed herein.

FIG. 9A is a diagram with a first UE communicating with a second UE, in accordance with the teachings disclosed herein.

FIG. 9B illustrates a timing diagram of bidirectional full-duplex sidelink communication with respect to a first UE and a second UE, in accordance with the teachings disclosed herein.

FIG. 10A illustrates a timing diagram of bidirectional full-duplex sidelink communication with respect to a desired signal and a reflected signal at a first UE and a second UE, in accordance with the teachings disclosed herein.

FIG. 10B illustrates a timing diagram of bidirectional full-duplex sidelink communication including timing adjustment with respect to a desired signal and a reflected signal at a first UE and a second UE, in accordance with the teachings disclosed herein.

FIG. 11 is an example communication flow between a base station, a first UE, and a second UE, in accordance with the teachings disclosed herein.

FIG. 12A is a diagram illustrating a first UE in communication with a second UE performing TA training, in accordance with the teachings disclosed herein.

FIG. 12B is a diagram illustrating a mapping of timing-adjusted transmissions while performing TA training, in accordance with the teachings disclosed herein.

FIG. 13 is a flowchart of a method of wireless communication at a first UE, in accordance with the teachings disclosed herein.

FIG. 14 is another flowchart of a method of wireless communication at the first UE, in accordance with the teachings disclosed herein.

FIG. 15 is a flowchart of a method of wireless communication with a first UE at a second UE, in accordance with the teachings disclosed herein.

FIG. 16 is another flowchart of a method of wireless communication with a first UE at a second UE, in accordance with the teachings disclosed herein.

FIG. 17 is a diagram illustrating an example of a hardware implementation for an example apparatus, in accordance with the teachings disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

A link between a UE and a base station may be established as an access link, for example, using a Uu interface. Other communication may be exchanged between wireless devices based on sidelink. For example, some UEs may communicate with each other directly using a device-to-device (D2D) communication link, such as sidelink. Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc.

A wireless device that has the capability of sidelink communication may include multiple transmitter-receiver points (TRPs). In some examples, a TRP may comprise an antenna panel. For example, a vehicle may have multiple TRPs, such as a front antenna panel and a rear antenna panel. Larger vehicles may have more than two TRPs. Although examples are provided for vehicular sidelink communication, the aspects presented here are applicable to non-vehicular wireless devices and are not limited to a vehicle application. TRPs are different radio frequency (RF) modules having a shared hardware and/or software controller. A UE may schedule sidelink communication per TRP. In some examples, the UE may have the capability of concurrent communication via the multiple TRPs. For example, the UE may have the capability of communication that overlaps in time via different TRPs. For example, the UE may transmit a first transmission via a first TRP that overlaps in time, at least partially, with a second transmission via a second TRP. In some examples, the UE may have the capability of full-duplex communication in which the UE transmits via one TRP concurrently (e.g., overlapping in time) with reception via a second TRP. For example, the UE may transmit a sidelink transmission via a front antenna panel while receiving sidelink communication via a rear antenna panel.

From the perspective of a wireless device communicating using full-duplex, the wireless device may transmit a first transmission (e.g., via a first TRP) while concurrently receiving a second transmission (e.g., via a second TRP). The transmission of the first transmission by the wireless device may occur via a transmission link (sometimes referred to as a “forward link” or a “transmission branch”) and the reception of the second transmission by the wireless device may occur via a reception link (sometimes referred to as a “reverse link” or a “reception branch”).

Full-duplex sidelink communication includes non-bidirectional full-duplex sidelink communication and bidirectional full-duplex sidelink communication. In non-bidirectional full-duplex sidelink communication, a first wireless device (e.g., a Node A) transmits a first transmission to a second wireless device while the first wireless device concurrently receives a second transmission from a third wireless device. In such examples, the first wireless device has the capability of full-duplex communication, while the second wireless device and the third wireless device may or may not have the capability of full-duplex communication. In bidirectional full-duplex sidelink communication, the first wireless device (e.g., the Node A) transmits the first transmission to the second wireless device (e.g., a Node B) while the first wireless device concurrently receives the second transmission from the second wireless device. In such examples, the first wireless device and the second wireless device each have the capability of full-duplex communication.

With full-duplex sidelink communication, there is the potential for self-interference. For example, a transmission from a first TRP of the UE may be received by a second TRP of the UE and may cause interference to sidelink transmission at the second TRP if it is performed concurrently with the transmission from the first TRP (e.g., in a full-duplex mode).

Aspects presented herein provide for the UE to perform a self-interference measurement (SIM) to measure the signal that is transmitted by the first TRP and received by the second TRP of the UE. The UE then applies a timing advance (TA) adjustment for bidirectional full-duplex sidelink communication, such as full-duplex V2X communication. The TA adjustment may be applied to the transmission link to improve the link quality of the reception link.

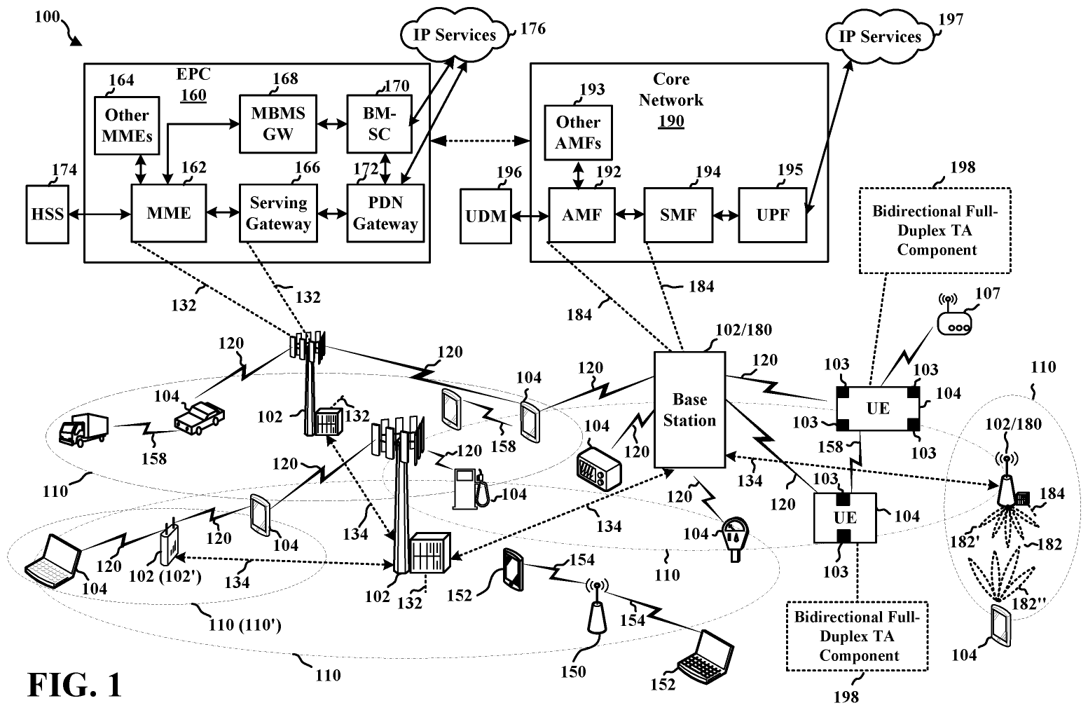

FIG. 1 is a diagram illustrating an example of a wireless communications system and an access network 100 including base stations 102 and 180 and UEs 104. FIG. 1 illustrates UEs 104 having multiple TRPs 103. For example, a UE 104, or another device communicating based on bidirectional full-duplex sidelink communication, may include a bidirectional full-duplex TA component 198 configured to perform a self-interference measurement on a unicast link with a second UE to determine a link quality. The example bidirectional full-duplex TA component 198 may also be configured to apply a TA adjustment for transmission or reception with the second UE based on the self-interference measurement.

In another configuration, the bidirectional full-duplex TA component 198 may be configured to facilitate wireless communication with a first UE at a second UE. For example, the bidirectional full-duplex TA component 198 may be configured to transmit and receive sidelink communication with the first UE in a full-duplex mode on a unicast link. The example bidirectional full-duplex TA component 198 may also be configured to apply a TA adjustment for transmission or reception of the sidelink communication with the first UE, the TA adjustment being based on interference at the first UE or the second UE.

The aspects presented herein may enable TA determination for bidirectional full-duplex sidelink communication capable devices (e.g., communication devices that have the capability of bidirectional full-duplex sidelink communication), which may facilitate improved full-duplex operation based on reduced self-interference.

Although the following description provides examples directed to 5G NR (and, in particular, to bidirectional full-duplex sidelink communication using 5G NR), the concepts described herein may be applicable to other similar areas, such as LTE, LTE-A, CDMA, GSM, and/or other wireless technologies, in which a UE may communicate in a bidirectional full-duplex mode.

In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

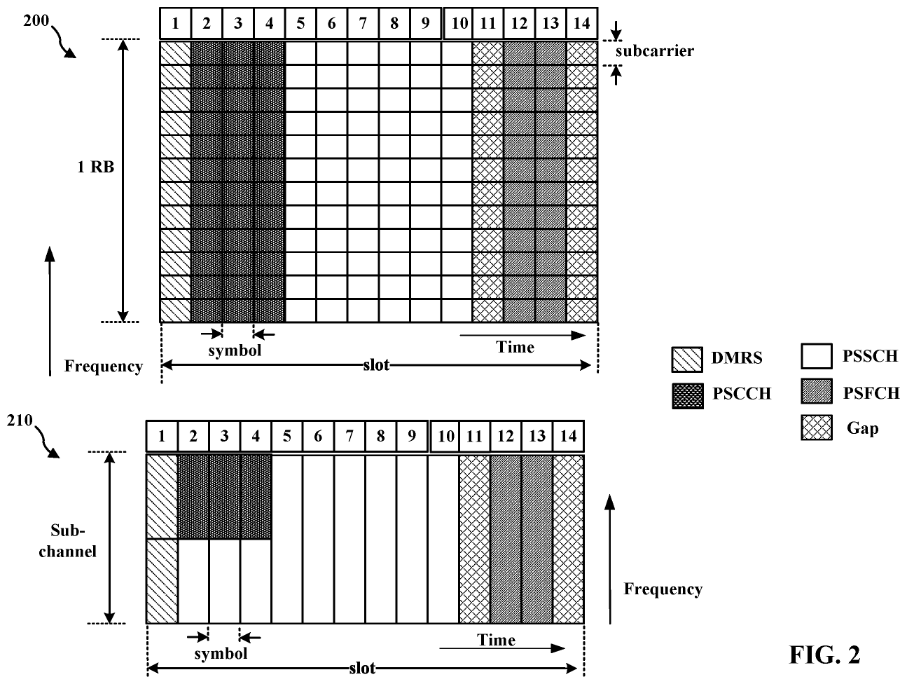

In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

The example of the wireless communications system of FIG. 1 (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MB SFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may comprise control information in PSCCH and some Res may comprise demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some examples.

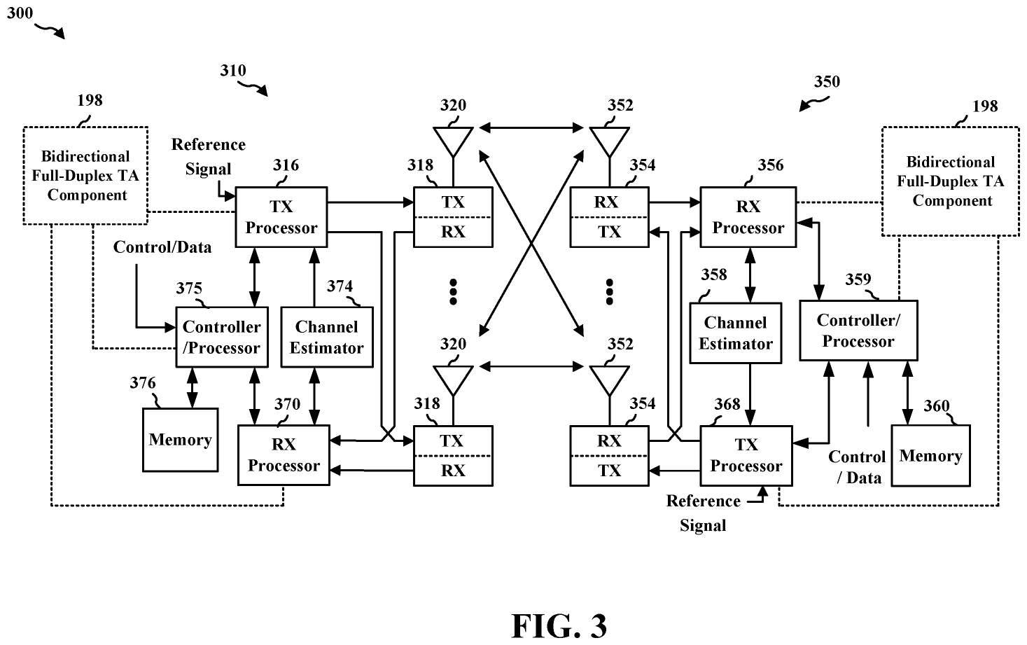

FIG. 3 is a block diagram 300 of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

As illustrated in FIG. 3, at least one of the TX processor 316 or 368, the RX processor 356 or 370, and the controller/processor 359 or 375 may be configured to perform aspects in connection with the bidirectional full-duplex TA component 198 of FIG. 1.

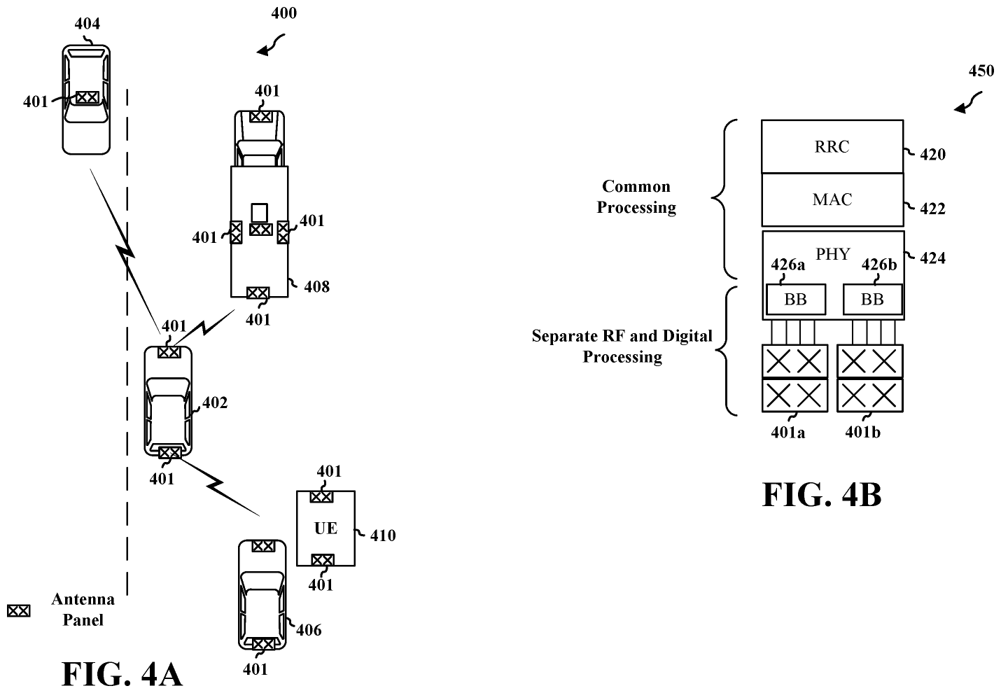

A sidelink-capable device may include multiple TRPs. For example, a vehicle may have multiple antenna panels, such as a front antenna panel and a rear antenna panel. Larger vehicles may have more than two TRPs. FIG. 4A is a diagram 400 showing an example with UEs 402, 406, and 410 having two TRPs 401, e.g., a front antenna panel and a rear antenna panel. FIG. 4A also illustrates a UE 408 associated with a larger vehicle having more than two TRPs 401, as well as a UE 404 having a single TRP 401. Although examples are provided for vehicular sidelink communication to illustrate the concept, the aspects presented here are applicable to non-vehicular sidelink-capable devices and are not limited to a vehicle application. For example, the UE 410 may be a non-vehicular UE.

Each TRP comprises different RF modules having a shared hardware and/or software controller. FIG. 4B illustrates a diagram 450 showing the processing at an RRC layer 420, a MAC layer 422, and part of a PHY layer 424 for multiple TRPs 401a and 401b that is common to both TRP 401a and TRP 401b. FIG. 4B illustrates that each TRP may have separate RF and digital processing. Each TRP may perform separate baseband processing 426a and 426b. Each TRP may comprise a different antenna panel or a different set of antenna elements (e.g., 401a and 401b) of a sidelink-capable device. The TRPs of the sidelink-capable device may be physically separated. For example, TRPs on a vehicle may be located at different locations of the vehicle. As an example, front and rear antenna panels on a vehicle may be separated by 3 meters, 4 meters, etc. The spacing between TRPs may vary based on the size of a vehicle and/or the number of TRPs associated with the vehicle. Each of the TRPs may experience a channel differently (e.g., experience a different channel quality) due to the different physical location, the distance between the TRPs, different line-of-sight (LOS) characteristics (e.g., a LOS channel in comparison to a non-LOS (NLOS) channel), blocking/obstructions, interference from other transmissions, among other reasons.

A sidelink-capable device (e.g., a device having the capability of sidelink communication) may schedule sidelink communication per TRP 401. As an example, a UE may schedule a V2X transmission for transmission from a particular TRP of a vehicle. In some examples, the sidelink-capable device may have the capability of concurrent communication via the multiple TRPs, e.g., communication via different TRPs that overlaps in time. For example, the UE 402 may transmit a first transmission (e.g., a first sidelink TB) via the front TRP 401 that overlaps in time, at least partially, with a second transmission (e.g., a second sidelink TB) via the rear TRP 401. The concurrent transmissions of the two TB s may be in the same resources or overlapping resources. In other examples, a sidelink-capable device may transmit a particular TB using one TRP or a subset of a larger group of TRPs. For example, the UE 408 is illustrated as having five TRPs 401 and may transmit a TB using a single TRP. Alternately, the UE 408 may transmit a TB using a subset of the five TRPs, e.g., two TRPs, three TRPs, or four TRPs.

A sidelink-capable device, such as a UE, may autonomously determine resources for sidelink transmissions by sensing, or monitoring, for reservations of other sidelink-capable devices. The autonomous resource selection may be referred to as “resource allocation mode 2,” a “decentralized” resource allocation mode, or a sensing-based sidelink resource allocation mode, e.g., where each sidelink-capable device selects its own sidelink resources for sidelink transmissions. In contrast to a centralized resource allocation mode (e.g., a resource allocation mode 1) in which a network entity may assign sidelink resources, in the decentralized sidelink resource allocation mode, a UE may autonomously select sidelink transmission resources based on a sensing and resource reservation procedure.

When a sidelink-capable device, such as a UE, is preparing to transmit data, the sidelink-capable device may select transmission resources from a candidate resource set from which previously reserved resources are excluded. In order to maintain the candidate resource set, the sidelink-capable device may monitor for resource reservations from other sidelink-capable devices. For example, the sidelink-capable device may receive SCI from other UEs including reservation information in a resource reservation field. The number of resources (e.g., sub-channels per subframe) reserved by a UE may depend on the size of data to be transmitted by the UE. The sidelink-capable device may exclude resources that are used and/or reserved by the other UEs from a candidate resource set. The exclusion of the reserved resources enables the UE to select/reserve resources for a transmission from the resources that are unused/unreserved. Although the example is described for a UE receiving reservations from another UE, the reservations may also be received from an RSU or other device communicating based on sidelink.

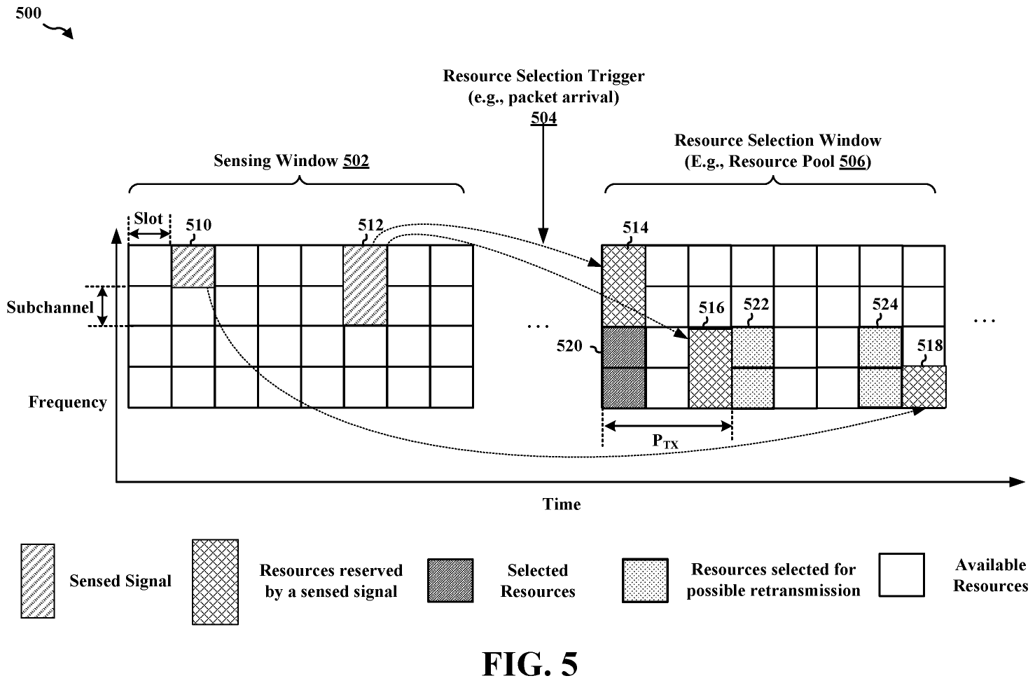

FIG. 5 is a diagram 500 showing time frequency resources for sidelink sensing and resource selection, e.g., mode 2 resource allocation. FIG. 5 shows reservations for sidelink transmissions 510, 512. The resource reservations for each UE may be in units of one or more sub-channels in the frequency domain (e.g., sub-channels 1 to 4), and may be based on one slot in the time domain. A UE may use resources in a first slot to perform an initial transmission, and may reserve resources in one or more future slots, e.g., for retransmissions. In some examples, up to two different future slots may be reserved by a particular UE for retransmissions. The reserved resource may be used for a retransmission of a packet or for transmission of a different packet. For example, the reservation may be for two retransmissions or for more than two retransmissions. The reservation may be for an initial transmission and a single transmission. The reservation may be for an initial transmission. The resource reservation may be chained, e.g., with a transmission A indicating a resource for transmission B. Transmission B may then indicate a resource for transmission C, and transmission C may indicate a resource for transmission D. The pattern may continue with transmission D indicating future resources. In another example, transmission A may indicate resources for transmissions B and C. Then, transmission B may indicate resources for transmissions C and D. The pattern may continue with transmission D indicating future resources.

A sidelink-capable device may identify available resources in a resource selection window 506 by monitoring for resource reservations during a sensing window 502. The sensing window 502 may be based on a range of slots and sub-channels. FIG. 5 illustrates an example sensing window 502 including 8 consecutive time slots and 4 consecutive sub-channels, which spans 32 resource blocks. The sidelink-capable device may monitor resources of a sidelink resource pool (e.g., the resource selection window 506), over the slots of the sensing window 502. FIG. 5 illustrates that the sidelink transmission 510 indicates a resource reservation for a resource 518, and the sidelink transmission 512 indicates a resource reservation for resources 514 and 522. For example, the sidelink transmissions 510, 512 may each include SCI that indicates the corresponding resource reservation.

A sidelink-capable device receiving the sidelink transmissions 510, 512 may exclude the resources 514, 516, and 518 as candidate resources in a candidate resource set based on the resource selection window 506. In some examples, the sidelink-capable device may exclude the resources 514, 516, or 518 based on whether a measured RSRP for the received SCI (e.g., in the sidelink transmission 510 or the sidelink transmission 512) meets a threshold. When a resource selection trigger occurs at 504, such as the sidelink-capable device having a packet for sidelink transmission, the sidelink-capable device may select resources for the sidelink transmission (e.g., including PSCCH and/or PSSCH) from the remaining resources of the resource pool within the resource selection window 506 after the exclusion of the reserved resources (e.g., 514, 516, and 518). FIG. 5 illustrates an example in which the sidelink-capable device selects a resource 520 for sidelink transmission. The sidelink-capable device may also select resources 522 and/or 524 for a possible retransmission. After selecting the resources for transmission, the sidelink-capable device may transmit SCI indicating a reservation of the selected resources. Thus, each sidelink-capable device may use the sensing/reservation procedure to select resources for sidelink transmissions from the available candidate resources that have not been reserved by other sidelink-capable devices.

A sidelink-capable device may support full-duplex sidelink communication via multiple TRPs. For example, the UE 402 in FIG. 4A may transmit a sidelink transmission via the front antenna panel at an overlapping time with reception of sidelink communication via the rear antenna panel.

Full-duplex operation in which a wireless device concurrently transmits and receives communication that overlaps in time may enable more efficient use of the wireless spectrum. Full-duplex operation may include simultaneous transmission and reception in a same frequency range, or partially overlapped frequency range, or separate frequency ranges.

For example, a UE, or other sidelink-capable device, may transmit communication from one antenna panel and may receive communication with another antenna panel. For example, the sidelink-capable device may transmit from one TRP concurrently with reception at another TRP. As an example, the UE 402 may transmit a sidelink transmission from a TRP at the front of the vehicle and may concurrently receive via a TRP at the rear of the vehicle. As another example, the sidelink-capable device may perform full-duplex communication from the same antenna panel. For example, the sidelink-capable device may receive sidelink communication using a first set of one or more antenna elements within the antenna panel while concurrently using a second set of one or more antenna elements of the antenna panel to transmit a sidelink transmission. In some examples, the full-duplex communication may be conditional on beam or spatial separation or other conditions. Full-duplex communication may reduce latency. Full-duplex communication may improve spectrum efficiency, e.g., spectrum efficiency per UE, with respect to the spectral efficiency of half-duplex communication that supports transmission or reception of information in one direction at a time without overlapping uplink and downlink communication. Full-duplex communication may enable more efficient use of wireless resources.

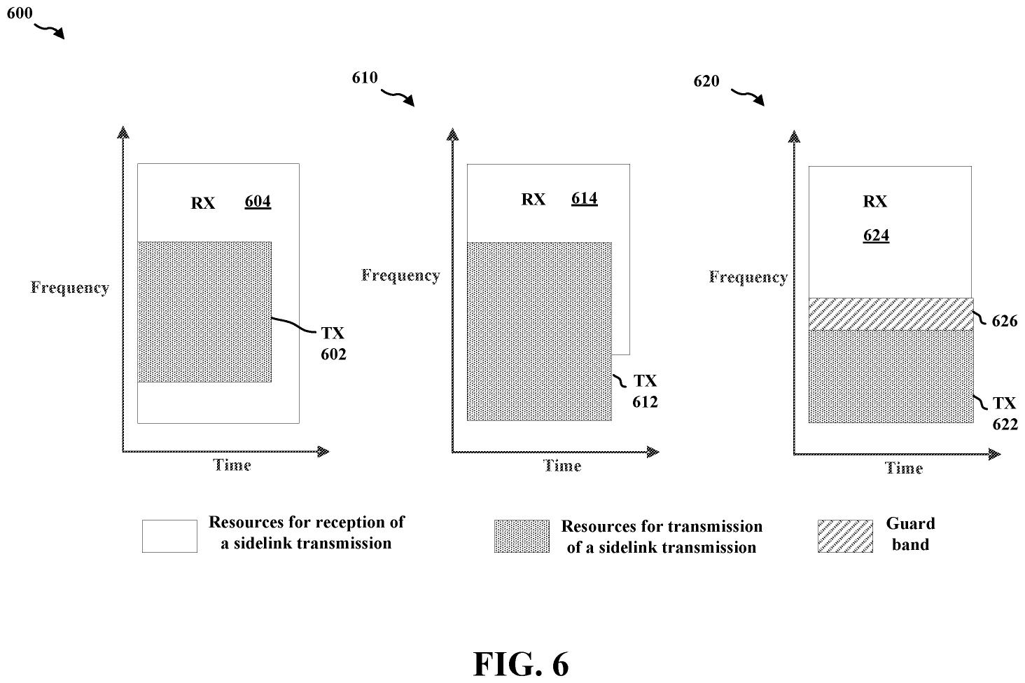

Full-duplex communication may be in a same frequency band. The transmitted and received communication may be in different frequency sub-bands, in the same frequency sub-band, or in partially overlapping frequency sub-bands. FIG. 6 illustrate a first example 600 and a second example 610 of in-band full-duplex (IBFD) resources (which may also be referred to as single-frequency full-duplex) and a third example 620 of sub-band full-duplex resources. In IBFD, signals may be transmitted and received in overlapping times and overlapping in frequency (e.g., a set of time-frequency resources). As shown in the first example 600, a time and a frequency allocation of transmission resources 602 may fully overlap with a time and a frequency allocation of reception resources 604. In the second example 610, a time and a frequency allocation of transmission resources 612 may partially overlap with a time and a frequency of allocation of reception resources 614.

IBFD is in contrast to sub-band frequency division duplex (FDD), where transmission and reception resources may overlap in time using different frequencies (e.g., a set of time-frequency resources that are overlapping in time and non-overlapping in frequency), as shown in the third example 620. In the third example 620, transmission resources 622 are separated from reception resources 624 by a guard band 626. The guard band may be frequency resources, or a gap in frequency resources, provided between the transmission resources 622 and the reception resources 624. Separating the frequency resources for transmission and reception with a guard band may help to reduce self-interference. Transmission and reception resources that are immediately adjacent to each other may be considered as having a guard band width of 0. As an output signal, e.g., from a UE transmitter may extend outside the transmission resources, the guard band may reduce interference experienced by the UE. Sub-band FDD may also be referred to as “flexible duplex”.

Due to the simultaneous Tx/Rx nature of full-duplex communication, a sidelink-capable device may experience self-interference caused by signal leakage from its transmitting TRP to its receiving TRP or from a transmitting set of one or more antenna elements to a receiving set of one or more antenna elements. In addition, the sidelink-capable device may also experience interference from other devices, such as transmissions from a second sidelink-capable device. The sidelink-capable device may also experience clutter interference, for example, due to a transmission from its transmitting TRP (or from a transmitting set of one or more antenna elements) being reflected by features in the environment and being received by its receiving TRP (to a receiving set of one or more antenna elements). Such interference (e.g., self-interference or interference caused by other devices) may impact the quality of the communication, or even lead to a loss of information.

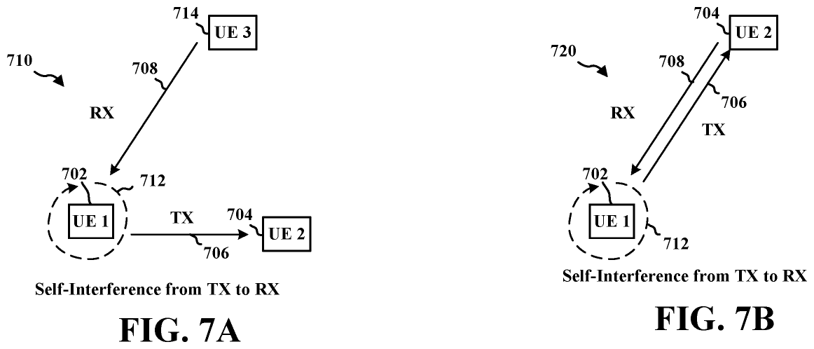

FIG. 7A illustrates an example of non-bidirectional full-duplex communication 710 in which a first UE 702 transmits a signal 706 to a second UE 704 concurrently with reception of a signal 708 from a third UE 714. FIG. 7A illustrates that the transmission of the signal 706 may be received by the receiving TRP (or receiving antenna elements) of the first UE 702 and cause self-interference 712 to the concurrent reception of the signal 708. In the illustrated example of FIG. 7, and from the perspective of the first UE 702, the transmission of the signal 706 to the second UE 704 may occur using a transmission link between the transmitting TRP (or transmitting antenna elements) of the first UE 702 and the second UE 704. The reception of the signal 708 from the third UE 714 may occur using a reception link between the third UE 714 and the receiving TRP (or receiving antenna elements) of the first UE 702.

FIG. 7B illustrates an example of bidirectional full-duplex communication 720 in which the first UE 702 concurrently transmits and receives communication with the second UE 704. Similar to the example in FIG. 7A, FIG. 7B illustrates that the transmission of the signal 706 from the first UE 702 may cause self-interference 712 to the reception of the signal 708 from the second UE 704.

In a communication network in which a UE is communicating with a base station (e.g., via a Uu interface), the UE may receive a configuration from the base station that causes the UE to apply a timing advance (TA) to uplink transmissions. For example, the timing of the uplink transmission may be advanced by a TA value with respect to a downlink receiving time. The TA value ensures that signals from UEs at different distances from the base station are aligned at the base station. For example, the propagation delay between a first UE and a base station may be smaller than the propagation delay for a second UE that is positioned further from the base station relative to the first UE. Thus, the base station may provide different TA values to each of the first UE and the second UE so that uplink transmissions from the respective UEs are aligned at the base station. That is, in a communication network in which the UE is communicating with the base station via a Uu interface, the TA may facilitate reducing the effect of the propagation delay on communication performance.

Wireless devices, such as V2X UEs, communicating with each other over sidelink may be based on a common timing. Example timing sources for the common timing include a Global Navigation Satellite System (GNSS), a cellular base station, or another wireless device. Wireless devices synchronized to the same timing source may transmit and/or receive based on the common timing. Wireless devices based on the common timing may incur a propagation delay (e.g., due to distances between the transmitting device and the receiving device) that may result in a misalignment of timing. However, due to the limited communication range associated with sidelink communication, the timing misalignment may be absorbed by a cyclic prefix (CP) portion of a sidelink transmission. That is, the impact to the communication performance may be limited.

For example, a sidelink transmission may include a cyclic prefix (CP) followed by a payload. The CP may include a cyclic shift of an end portion of the payload. A receiver receiving the sidelink transmission may perform a transformation function on the payload to facilitate decoding the sidelink transmission. Thus, self-interference that results in the CP portions of the respective received sidelink transmissions overlapping, at least partially, in time may be ignored. However, when the misalignment of timing causes the CP portions of the respective received sidelink transmissions to be offset so that they do not overlap in time, then the self-interference may be non-manageable (e.g., may not be ignored) and may result in the degradation of communication performance.

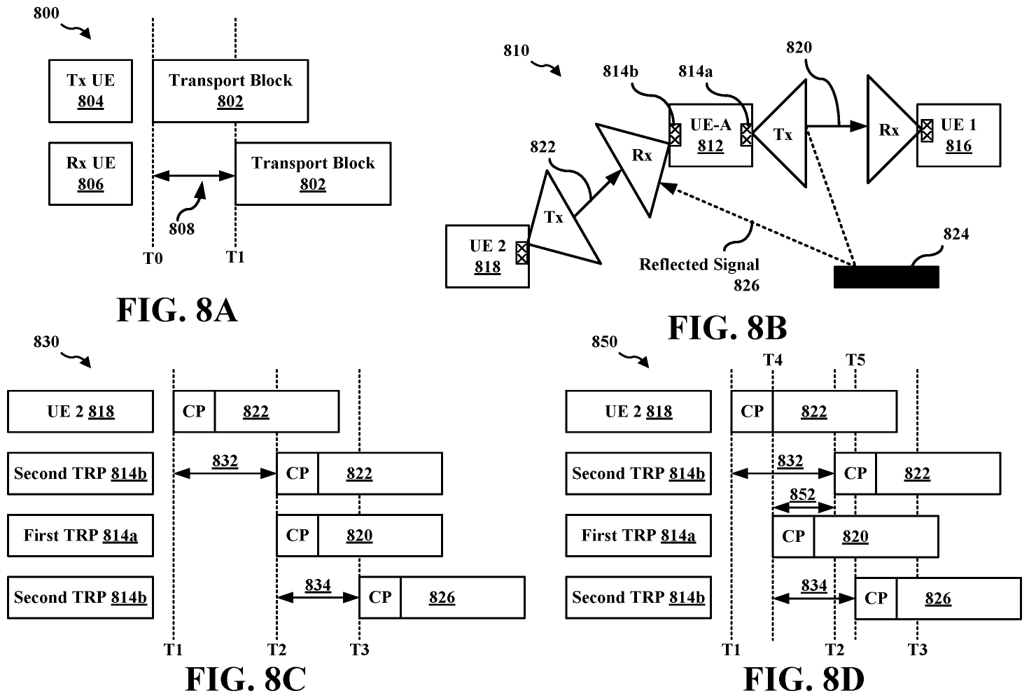

FIG. 8A illustrates an example timing diagram 800 for a transport block 802 with respect to a transmitting UE 804 (“Tx UE”) and a receiving UE 806 (“Rx UE”), as presented herein. In the illustrated example, the transmitting UE 804 transmits the transport block 802 at a time TO. The receiving UE 806 starts receiving the transport block 802 at a time T1. The interval between when the transmitting UE 804 transmits the transport block 802 (e.g., at the time TO) and when the receiving UE 806 starts receiving the transport block 802 (e.g., at the time T1) indicates a propagation delay 808. As described above, the length of the propagation delay 808 may depend on the distance between the transmitting UE 804 and the receiving UE 806.

FIG. 8B is a diagram 810 with a first node 812 (UE-A) communicating with a first UE 816 and a second UE 818, as presented herein. In the illustrated example, the first node 812 is a UE that has the capability of full-duplex sidelink communication and the first UE 816 and the second UE 818 are communicating in a half-duplex mode. As shown in FIG. 8B, the first node 812 includes two TRPs, e.g., a first TRP 814a (or a first antenna panel) and a second TRP 814b (or a second antenna panel), that facilitate concurrent transmission and reception of signals. For example, the first node 812 may transmit a first signal 820 (e.g., a first sidelink transport block) to the first UE 816 that overlaps in time, at least partially, with reception of a second signal 822 from the second UE 818. The first node 812 may transmit the first signal 820 using the first TRP 814a and may receive the second signal 822 using the second TRP 814b.

In the illustrated example of FIG. 8B, at least a portion of the first signal 820 may be received by the second TRP 814b. For example, a portion of the first signal 820 may reflect off an object 824 in the environment and be received by the second TRP 814b. Such a reflected signal 826 may result in self-interference (sometimes referred to as “clutter interference”) that may be measured by the first node 812. Moreover, if the arrival of the reflected signal 826 overlaps with the arrival of the second signal 822 at the second TRP 814b, the reflected signal 826 may impact the quality of the second signal 822, or even lead to a loss of information.

As shown in FIG. 8B, the first node 812 is operating in a non-bidirectional full-duplex mode. For example, the first node 812 may establish a transmission link between the first TRP 814a and the first UE 816 to transmit the first signal 820 to the first UE 816. The first node 812 may also establish a reception link between the second TRP 814b and the second UE 818 to receive the second signal 822. Since the transmission link and the reception link are associated with different endpoints (e.g., the first UE 816 and the second UE 818, respectively), the timing of the respective links can be independently controlled (e.g., the timings of the transmission link and the reception link are not coupled).

For example, the first node 812 may adjust the reception timings of the reflected signal 826 and/or the second signal 822 so that the receptions occur within a cyclic prefix and, thus, the impact of the clutter interference at the second TRP 814b can be reduced. In some examples, the first node 812 may request that the second UE 818 adjust the timing of the transmission of the second signal 822 so that the arrivals of the reflected signal 826 and the second signal 822 at the second TRP 814b occur within the cyclic prefix. In other examples, the first node 812 may adjust the timing of the transmission of the first signal 820 so that the arrivals of the reflected signal 826 and the second signal 822 at the second TRP 814b occur within the cyclic prefix.

FIG. 8C illustrates a timing diagram 830 of non-bidirectional full-duplex sidelink communication with respect to a desired signal (e.g., the second signal 822) and the reflected signal 826, as presented herein. In the illustrated example of FIG. 8C, the second UE 818 transmits the second signal 822 at a time T1. The second signal 822 includes a cyclic prefix (CP) portion. The second TRP 814b of the first node 812 receives the second signal 822 at a time T2. An interval between the time T1 and the time T2 represents a first propagation delay 832.

As shown in the illustrated example of FIG. 8C, the first node 812 transits the first signal 820 concurrently with the reception of the second signal 822 from the second UE 818. For example, the first node 812 transmits the first signal 820 at the time T2 so that the communication of the first signal 820 and the second signal 822 overlaps, at least partially, in time. As shown in FIG. 8C, the first signal 820 includes a CP portion.

In some scenarios, at least a portion of a signal transmitted by a transmitting TRP of a UE may be reflected, for example, by an object in an environment, and received by a receiving TRP of the UE. For example, at least a portion of the first signal 820 may be reflected by the object 824 and the reflected signal 826 may be received by the second TRP 814b. In the illustrated example of FIG. 8C, the second TRP 814b of the first node 812 receives the reflected signal 826 at a time T3. An interval between the time T2 (e.g., when the first TRP 814a transmits the first signal 820) and the time T3 (e.g., when the second TRP 814b receives the first signal 820 after the first signal 820 is reflected by the object 824) represents a second propagation delay 834.

In the example of FIG. 8C, the second signal 822 and the reflected signal 826 are received at the second TRP 814b at different times, but they still overlap in time. As described above, if the arrival of the reflected signal 826 overlaps with the arrival of the second signal 822 at the second TRP 814b, the reflected signal 826 may impact the quality of the second signal 822, or even lead to a loss of information. However, if the timing of the second signal 822 and/or the reflected signal 826 is adjusted, the respective signals 822, 826 may be received so that the respective CP portions overlaps. In such scenarios, the negative impact to the communication performance may be reduced and the self-interference may be manageable.

FIG. 8D illustrates a timing diagram 850 of non-bidirectional full-duplex sidelink communication including timing adjustment with respect to a desired signal (e.g., the second signal 822) and the reflected signal 826, as presented herein. In the illustrated example of FIG. 8D, the first node 812 adjusts the transmission time of the first signal 820 so that reception of the CP portion of the corresponding reflected signal 826 overlaps in time with the reception of the CP portion of the second signal 822.

For example, based on the second propagation delay 834, the first node 812 may apply a timing advance (TA) adjustment so that the first signal 820 is transmitted at a time that occurs earlier in time than the time T2. For example, in FIG. 8D, the first node 812 may apply a TA adjustment with a TA value 852 that is negative so that the first TRP 814a transmits the first signal 820 at a time T4 that occurs after the time T1 and before the time T2. As a result, the second TRP 814b receives the reflected signal 826 at a time T5 that occurs after the time T2 and before the time T3. In addition, the CP portion of the second signal 822 and the CP portion of the reflected signal 826 overlap, at least partially, in time. As a result, the self-interference measurement associated with the reception of the second signal 822 and the reflected signal 826 may be reduced (or absorbed) and the potential for loss of information (e.g., with respect to the second signal 822) may be reduced.

Although the example of FIG. 8D illustrates applying a TA adjustment with a negative TA value that shifts the transmission time of the first signal 820 to an earlier time relative to the corresponding transmission time in the example of FIG. 8C, other examples may apply a TA adjustment with a positive TA value so that the transmission of the first signal 820 is delayed (e.g., occurs at a time after the time T2). Additionally, or alternatively, the first node 812 may request that the second UE 818 adjust the transmission of the second signal 822 to reduce clutter interference and to improve communication performance.

In the illustrated examples of FIGS. 8B, 8C, and 8D, the first node 812 is operating in a non-bidirectional full-duplex mode. For example, the first node 812 establishes a first link (e.g., with the first TRP 814a) with the first UE 816 to transmit the first signal 820 and establishes a second link different from the first link (e.g., with the second TRP 814b) with the second UE 818 to receive the second signal 822. As a result, the timings of the respective links may be independently controlled or adjusted.

However, in some examples, a sidelink-capable device may operate in a bidirectional full-duplex mode. In such examples, the sidelink-capable device may communicate on a unicast link with another sidelink-capable device. The unicast link may comprise a bidirectional link including a reception link and a transmission link.

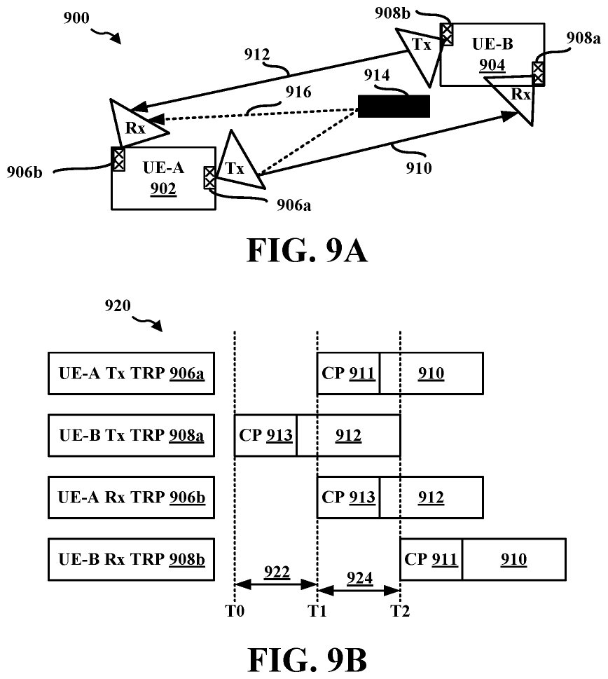

FIG. 9A is a diagram 900 with a first UE 902 (UE-A) communicating with a second UE 904 (UE-B), as presented herein. In the illustrated example, the first UE 902 and the second UE 904 are UEs that have the capability of full-duplex sidelink communication. As shown in FIG. 9A, the first UE 902 includes two TPRs, e.g., a first TRP 906a (or a first antenna panel) and a second TRP 906b (or a second antenna panel). The second UE 904 includes two TRPs, e.g., a first TRP 908a (or a first antenna panel) and a second TRP 908b (or a second antenna panel). The TRPs 906a, 906b of the first UE 902 and the TRPs 908a, 908b of the second UE 904 facilitate concurrent transmission and reception of signals.

As shown in FIG. 9A, the first UE 902 may transmit a first signal 910 (e.g., a first sidelink transport block) to the second UE 904. The first UE 902 may also receive a second signal 912 (e.g., a second sidelink transport block) from the second UE 904. Aspects of the first signal 910 and the second signal 912 may be similar to the transport block 802 of FIG. 8A. The first UE 902 may transmit the first signal 910 using the first TRP 906a (e.g., a transmitting TRP of the first UE 902) and may receive the second signal 912 using the second TRP 906b (e.g., a receiving TRP of the first UE 902). The second UE 904 may receive the first signal 910 using the first TRP 908a (e.g., a transmitting TRP of the second UE 904) and may transmit the second signal 912 using the second TRP 908b (e.g., a receiving TRP of the second UE 904).

FIG. 9B illustrates a timing diagram 920 of sidelink communication with respect to the first signal 910 and the second signal 912, as presented herein. In the illustrated example of FIG. 9B, the second UE 904 transmits the second signal 912 at a time TO. For example, the transmitting TRP of the second UE (e.g., the second TRP 908b) may transit the second signal 912 at the time TO. As shown in FIG. 9B, the second signal 912 includes a CP portion 913. The first UE 902 receives the second signal 912 at a time T1. For example, the receiving TRP of the first UE (e.g., the second TRP 906b) may receive the second signal 912 at the time T1. A first delay 922 (e.g., an interval between the time T0 and the time T1) represents a propagation delay for when the second UE 904 transmits the second signal 912 and the first UE 902 receives the second signal 912.

In FIG. 9B, the first UE 902 transmits the first signal 910 at the time T1. For example, the transmitting TRP of the first UE (e.g., the first TRP 906a) may transmit the first signal 910 at the time T1. As shown in FIG. 9B, the first signal 910 includes a CP portion 911. The second UE 904 receives the first signal 910 at a time T2. For example, the receiving TRP of the second UE (e.g., the second TRP 908b) may receive the first signal 910 at the time T2. A second delay 924 (e.g., an interval between the time T1 and the time T2) represents a propagation delay for when the first UE 902 transmits the first signal 910 and the second UE 904 receives the first signal 910.

In the illustrated example of FIG. 9B, the communication (e.g., the transmission and reception) of the signals 910, 912 at the respective UEs 902, 904 occurs with both of the UEs 902, 904 operating in a full-duplex mode. For example, the first UE 902 transmits the first signal 910 that overlaps, at least partially, in time with the reception of the second signal 912. In a similar manner, the second UE 904 transmits the second signal 912 that overlaps, at least partially, in time with the reception of the first signal 910. The UEs 902, 904 may be operating in a single-frequency full-duplex mode or a sub-band full-duplex mode. Moreover, the UEs 902, 904 are operating in a bidirectional full-duplex mode. For example, the UEs 902, 904 may establish bidirectional unicast links to facilitate the full-duplex communication. For example, and from the perspective of the first UE 902, the first UE 902 may establish a transmission link between the first TRP 906a of the first UE 902 and the first TRP 908a of the second UE 904 to facilitate transmitting from the first UE 902 to the second UE 904. The first UE 902 may also establish a reception link between the second TRP 906b of the first UE 902 and the second TRP 908b of the second UE 904 to facilitate receiving from the second UE 904 at the first UE 902.

In some examples, a signal transmitted by a UE may also be received by the UE. Referring again to the example of FIG. 9A, at least a portion of the first signal 910 transmitted by the first TRP 906a may be received by the second TRP 906b of the first UE 902. For example, a portion of the first signal 910 may be reflected by an object 914 in the environment and be received by the second TRP 906b. Such a signal (e.g., a reflected signal 916 corresponding to the first signal 910) may result in self-interference (sometimes referred to as “clutter interference”) that may be measured by the first UE 902. Moreover, if the reception of the reflected signal 916 and the second signal 912 at the second TRP 906b overlaps in time, the reflected signal 916 may negatively impact the quality of the second signal 912 at the first UE 902, or even lead to a loss of information.

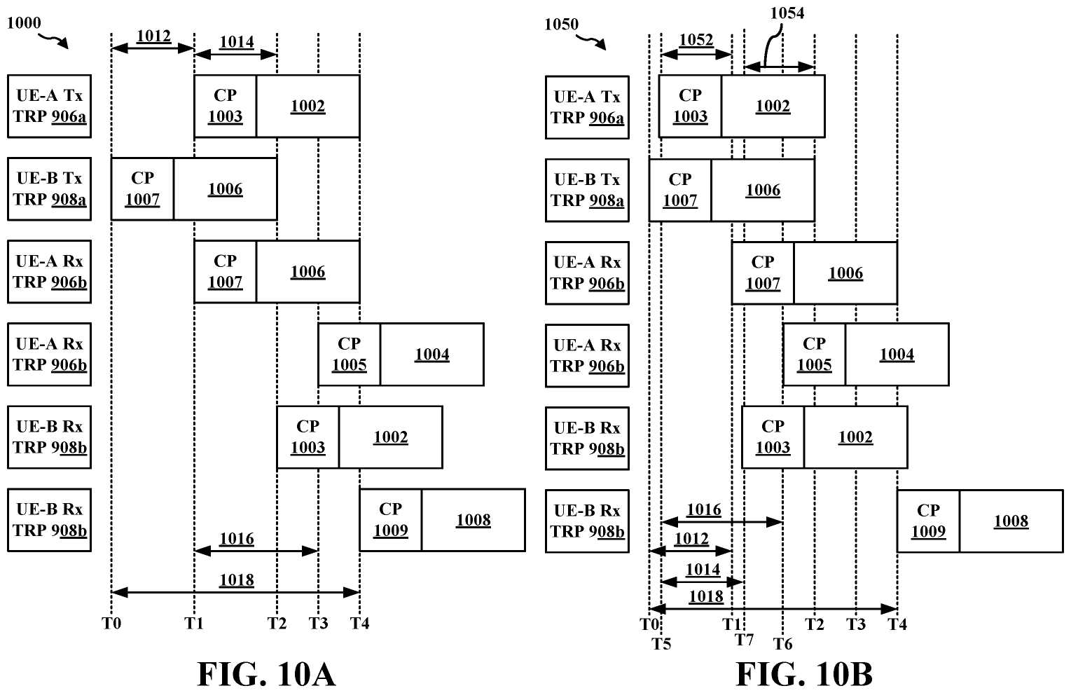

FIG. 10A illustrates a timing diagram 1000 of sidelink communication with respect to a first signal 1002, a first reflected signal 1004, a second signal 1006, and a second reflected signal 1008, as presented herein. Aspects of the first signal 1002 may be similar to the first signal 910 of FIGS. 9A and 9B, aspects of the second signal 1006 may be similar to the second signal 912 of FIGS. 9A and 9B, and aspects of the first reflected signal 1004 may be similar to the reflected signal 916 of FIG. 9A.

Similar to the example of FIG. 9B, the example timing diagram 1000 indicates that the second UE 904 transmits the second signal 1006, including a CP portion 1007, at a time TO. The first UE 902 receives the second signal 1006 at a time T1. A first delay 1012 (e.g., an interval between the time T0 and the time T1) represents a propagation delay for when the second UE 904 transmits the second signal 1006 and the first UE 902 receives the second signal 1006.

Similarly, the first UE 904 transmits the first signal 1002, including a CP portion 1003, at the time T1. The second UE 904 receives the first signal 1002 at a time T2. A second delay 1014 (e.g., an interval between the time T1 and the time T2) represents a propagation delay for when the first UE 902 transmits the first signal 1002 and the second UE 904 receives the first signal 1002.

The example of FIG. 10A also includes the reception of the first reflected signal 1004 at the first UE 902. For example, the receiving TRP of the first UE (e.g., the second TRP 906b) receives the first reflected signal 1004 at a time T3. The first reflected signal 1004 includes a CP portion 1005. A third delay 1016 (e.g., an interval between the time T1 and the time T3) represents a propagation delay for when the first UE 902 transmits the first signal 1002 and the first UE 902 receives the first reflected signal 1004 corresponding to the first signal 1002. For example, the third delay 1016 may include a first interval representing the time it takes for the first signal 1002 to travel from the first UE 902 to an object in the environment and may include a second interval representing the time it takes for the first reflected signal 1004 to travel from the object in the environment back to the first UE 902.

In the illustrated example of FIG. 10A, the second signal 1006 may be reflected (e.g., by an object in the environment) and received by the second UE 904. For example, the receiving TRP of the second UE (e.g., the second TRP 908b) may receive the second reflected signal 1008 at a time T4. The second reflected signal 1008 includes a CP portion 1009. A fourth delay 1018 (e.g., an interval between the time T0 and the time T4) represents a propagation delay for when the second UE 904 transmits the second signal 1006 and the second UE 904 receives the second reflected signal 1008. For example, the fourth delay 1018 may include a first interval representing the time it takes for the second signal 1006 to travel from the second UE 904 to an object in the environment and may include a second interval representing the time it takes for the second reflected signal 1008 to travel from the object in the environment back to the second UE 904.

As shown in FIG. 10A, the reception of the second signal 1006 and the first reflected signal 1004 at the receiving TRP of the first UE (e.g., the second TRP 906b) overlap, at least partially, in time. However, the CP portions 1005, 1007 of the respective signals 1004, 1006 do not overlap in time. As a result, the self-interference measurement at the first UE 902 may be high and, thus, may result in reduced communication performance. Similarly, the reception of first signal 1002 and the second reflected signal 1008 at the receiving TRP of the second UE (e.g., the second TRP 908b) overlap, at least partially in time. However, the CP portions 1003, 1009 of the respective signals 1002, 1008 do not overlap in time. As a result, the self-interference measurement at the second UE 904 may be high and, thus, may result in reduced communication performance.

FIG. 10B illustrates a timing diagram 1050 of bidirectional full-duplex sidelink communication including timing adjustment with respect to a desired signal and the corresponding reflected signal, as presented herein. In the illustrated example of FIG. 10B, the first UE 902 adjusts the transmission time of the first signal 1002 so that reception of the CP portion 1005 of the corresponding first reflected signal 1004 overlaps in time with the reception of the CP portion 1007 of the second signal 1006.

For example, based on the second delay 1014, the first UE 902 may apply a TA adjustment so that the first UE 902 transmits the first signal 1002 at a time that occurs before the time T1. For example, in FIG. 10B, the first UE 902 may apply a TA adjustment with a TA value 1052 that is negative so that the first UE 902 transmits the first signal 1002 at a time T5 that occurs after the time T0 and before the time T1. As a result, the first UE 902 receives the first reflected signal 1004 at a time T6 that occurs after the time T1 and before the time T2. In addition, the CP portion 1007 of the second signal 1006 and the CP portion 1003 of the first reflected signal 1004 overlap, at least partially, in time. As a result, the self-interference measurement associated with the reception of the second signal 1006 and the first reflected signal 1004 may be reduced (or absorbed) and the potential for loss of information (e.g., with respect to the second signal 1006 at the first UE 902) may be reduced.

As shown, the first delay 1012 representing the propagation delay of the second signal 1006 from the second UE 904 to the first UE 902 and the second delay 1014 representing the propagation delay of the first signal 1002 from the first UE 902 to the second UE 904 is the same in the examples of FIGS. 10A and 10B. Similarly, the third delay 1016 representing the propagation delay associated with the first reflected signal 1004 and the fourth delay 1018 representing the propagation delay associated with the second reflected signal 1008 is the same in the examples of FIGS. 10A and 10B.

However, as shown in FIG. 10B, adjusting the timing of the transmission of the first signal 1002 also has an effect at the second UE 904. For example, the second UE 904 may receive the first signal 1002 at a time T7 that occurs before the time T2. In the illustrated example, a timing gap 1054 (e.g., an interval between the time T7 when the second UE 904 receives the timing-adjusted first signal 1002 and the time T2 when the second UE 904 received the non-adjusted first signal 1002) represents an increase in time. The timing gap 1054 also corresponds to an increase in timing between when the second UE 904 receives the first signal 1002 and the first reflected signal 1004. In particular, the timing gap 1054 indicates that the timing difference between the first signal 1002 and the second reflected signal 1008 at the second UE 904 is increased.

Although the example of FIG. 10B illustrates applying a TA adjustment with a negative TA value that shifts the transmission of the first signal 1002 to an earlier time relative to the corresponding transmission time in the example of FIG. 10A, other examples may apply a TA adjustment with a positive TA value so that the transmission of the first signal 1002 is delayed (e.g., the transmission time occurs at a time after the time T2 of FIG. 10B). Additionally, or alternatively, the first UE 902 may request that the second UE 904 adjust the transmission time of the second signal 1006 to reduce clutter interference and to improve communication performance.

As shown in FIG. 10B, adjusting the timing of the transmission of one signal while communicating in a bidirectional full-duplex mode may improve (e.g., reduce) clutter-interference at one UE, but may also increase (or have relatively little change) of clutter-interference at the other UE. That is, the effect on clutter-interference timing with respect to the reception time at either UE is coupled.

Aspects disclosed herein provide techniques for determining a TA adjustment at the first UE and the second UE based on the coupling of the reception timing associated with bidirectional full-duplex sidelink communication. For example, aspects disclosed herein facilitate determining a TA adjustment for a transmission link and/or a reception link so that the CP portions of a signal and a reflected signal overlap, at least partially, in time. As a result, the self-interference due to the reception of the reflected signal may be managed (or ignored) and the performance of the bidirectional full-duplex sidelink communication is not degraded.

In some examples, the first UE and the second UE may perform TA training and/or refinement to determine a TA adjustment to apply. For example, the first UE may be configured with a first set of TA candidates and the second TA may be configured with a second set of TA candidates. The first UE and the second UE may exchange transmissions based on the respective sets of TA candidates and determine a TA pair that results in the least degradation in link quality. In some examples, the determined TA pair may correspond to one or more TA adjustments that allow for the link quality of a particular link to satisfy a Quality of Service (QoS) threshold. For example, the first UE and the second UE may identify a subset of TA pairs that allow communications on the transmission link and/or the reception link to satisfy a minimum QoS threshold. In such examples, the UEs may select the TA to apply from the subset of TA pairs.

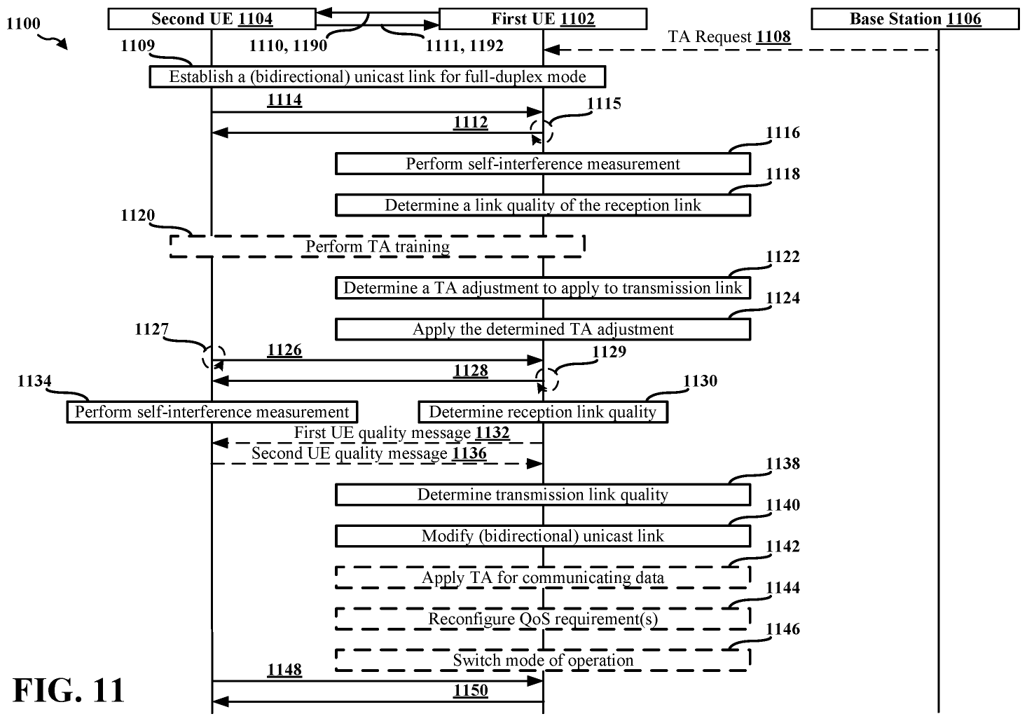

FIG. 11 illustrates an example communication flow 1100 between a first UE 1102, a second UE 1104, and a base station 1106, as presented herein. In the illustrated example, the communication flow 1100 facilitates the first UE 1102 and/or the second UE 1104 determining a TA adjustment to apply to reduce self-interference in view of the coupling of links associated with bidirectional full-duplex sidelink communication between the first UE 1102 and the second UE 1104. Aspects of the first UE 1102 and the second UE 1104 may be implemented by the UE 104 of FIG. 1, and/or the devices 310, 350 of FIG. 3. Aspects of the base station 1106 may be implemented by the base station 102/180 of FIG. 1. Although not shown in the illustrated example of FIG. 11, it may be appreciated that in additional or alternative examples, the base station 1106 may be in communication with one or more other base stations or UEs, and/or one or both of the UEs 1102, 1104 may be in communication with one or more other base stations or UEs.

In the illustrated example of FIG. 11, the first UE 1102 and the second UE 1104 both have the capability of full-duplex sidelink communication. The full-duplex sidelink communication may include a single-frequency full-duplex mode and/or a sub-band full-duplex mode (e.g., as described in connection with the examples 600, 610, 620 of FIG. 6).

At 1109, the first UE 1102 and the second UE 1104 establish a unicast link for full-duplex mode operation. The unicast link may comprise a bidirectional link that includes a transmission link 1110 (sometimes referred to as a “forward link” or a “transmission branch”) and a reception link 1111 (sometimes referred to as a “reverse link” or a “reception branch”). In the illustrated example, the sidelink transmissions are described from the perspective of the first UE 1102. For example, the first UE 1102 may receive a sidelink transmission from the second UE 1104 via the reception link 1111 of the first UE 1102 and/or the first UE 1102 may transmit a sidelink transmission to the second UE 1104 via the transmission link 1110 of the first UE 1102.

As shown in FIG. 11, the first UE 1102 and the second UE 1104 communicate using the bidirectional unicast link. For example, the first UE 1102 may transmit a first sidelink transmission 1112 to the second UE 1104 via the transmission link 1110. The first UE 1102 may also receive a second sidelink transmission 1114 from the second UE 1104 via the reception link 1111. The first UE 1102 may transmit the first sidelink transmission 1112 while concurrently receiving the second sidelink transmission 1114. For example, the transmission of the first sidelink transmission 1112 and the reception of the second sidelink transmission 1114 may overlap, at least partially, in time.

As described above in connection with FIGS. 9A and 10A, in some scenarios, a signal transmitted by a UE may be reflected and received by the UE. For example, at least a portion of the first sidelink transmission 1112 may be reflected by an object in the environment and the first UE 1102 may receive a reflected signal 1115 corresponding to the first sidelink transmission 1112.

At 1116, the first UE 1102 performs self-interference measurements (SIM) based on signals received via the reception link 1111. In some examples, the first UE 1102 may perform the SIM by performing reference signal received power (RSRP) measurements and/or received signal strength indicator (RSSI) measurements on time-frequency resources used by the first UE 1102 to transmit one or more reference signals. For example, when operating in a single-frequency full-duplex mode, the first UE 1102 may perform RSRP measurements and/or RSSI measurements on a set of time-frequency resources on which the first UE 1102 transmits one or more reference signals. In examples in which the first UE 1102 is operating in a sub-band full-duplex mode, the first UE 1102 may perform RSSI measurements on a set of time-frequency resources that are overlapping in time and non-overlapping in frequency with the time-frequency resources on which the first UE 1102 transmits the one or more reference signals.

At 1118, the first UE 1102 determines a link quality of the reception link 1111. For example, the first UE 1102 may determine the link quality of the reception link 1111 based on the SIM (e.g., at 1116). In some examples, the link quality of the reception link 1111 may include a signal-to-interference-and-noise ratio (SINR) (e.g., a reference signal received quality (RSRQ)), a throughput, and/or reliability measures (e.g., a block error rate (BER)).

At 1122, the first UE 1102 determines a TA adjustment to apply to the transmission link 1110. In some examples, the TA adjustment may include a negative value and cause the first UE 1102 to transmit transmissions using the transmission link 1110 at an earlier time (e.g., as shown in FIG. 10B). In some examples, the TA adjustment may include a positive value and cause the first UE 1102 to delay transmitting transmissions using the transmission link 1110. Applying the TA adjustment to the transmission link 1110 may improve the link quality of the reception link 1111.

In some examples, the first UE 1102 may determine the TA adjustment based on one or more propagation times of the reception link 1111 and the reflected signal. For example, and referring to the example of FIG. 10B, the first UE 1102 may determine the first delay 1012 representing the time it takes to receive the second signal 1006 via the reception link 1111 and/or the third delay 1016 representing the time it takes to receive the first reflected signal 1004. The first UE 1102 may use the propagation times (e.g., the first delay 1012 and/or the third delay 1016) to determine the TA adjustment to apply so that the self-interference is manageable. For example, the first UE 1102 may determine the TA adjustment so that the CP portion of the signal received via the reception link 1111 and the CP portion of the reflected signal overlap, at least partially, in time.

In some examples, the first UE 1102 may determine the TA adjustment based on one or more signal strength measurements (e.g., RSRP) when the first UE 1102 is operating in a half-duplex mode. For example, the one or more signal strength measurements may correspond to the link strength of the clutter-interference (e.g., due to the reflected signal 1115) and the reception link 1111. The first UE 1102 may determine the TA adjustment so that the link strength may be improved.

At 1124, the first UE 1102 applies the determined TA adjustment. For example, the first UE 1102 may adjust the timing of transmissions using the transmission link 1110 to an earlier time (e.g., by applying a negative TA value) or to a later time (e.g., by applying a positive TA value). The first UE 1102 transmits a timing-adjusted sidelink transmission 1128 using the transmission link 1110 based on the determined TA adjustment. The first UE 1102 may also concurrently (e.g., overlapping, at least partially, in time) a sidelink transmission 1126 from the second UE 1104 via the reception link 1111.

At 1130, the first UE 1102 determines a reception link quality. The reception link quality may include a link quality of the reception link 1111 based on the reception of the sidelink transmission 1126 and clutter-interference (e.g., based on reception of a reflected signal 1129 corresponding to the timing-adjusted sidelink transmission 1128). For example, the first UE 1102 may measure the link quality at the reception link 1111 of the first UE 1102. In some examples, determining the reception link quality may include determining whether the reception link quality satisfies (e.g., is equal to or exceeds) a minimum quality threshold to maintain a Quality of Service (QoS) of the reception link 1111.

In some examples, the first UE 1102 may transmit a first UE quality message 1132 based on the reception link quality to the second UE 1104. The first UE quality message 1132 may comprise a measurement report and/or an indication. In some examples, the first UE quality message 1132 may comprise a measurement report including the link quality of the reception link 1111 measured by the first UE 1102 (e.g., the reception link quality). In some examples, the first UE quality message 1132 may comprise an indication indicating whether the reception link quality satisfies (e.g., is equal to or exceeds) a minimum quality threshold to maintain a Quality of Service (QoS) of the reception link 1111.

At 1134, the second UE 1104 performs self-interference measurements based on signals that the second UE 1104 receives. For example, the second UE 1104 may perform the SIM by performing RSPR measurements and/or RSSI measurements on time-frequency resources used by the second UE 1104 to transit one or more reference signals. In some examples, the SIM performed by the second UE 1104 may be based on the timing-adjusted sidelink transmission 1128 that the second UE 1104 receives (e.g., via the transmission link 1111 of the first UE 1102). In some examples, the SIM may indicate the presence of clutter interference, for example, due to a reflected signal 1127 corresponding to the sidelink transmission 1126. The second UE 1104 may transmit a second UE quality message 1136 based on the SIM. Aspects of the second UE quality message 1136 may be similar to the first UE quality message 1132. For example, the second UE quality message 1136 may comprise a measurement report and/or an indication.

At 1138, the first UE 1102 determines a transmission link quality. The transmission link quality may include a link quality of the transmission link 1110 based on the applied TA adjustment. The first UE 1102 may determine the transmission link quality based on the second UE quality message 1136 received from the second UE 1104 via the reception link 1111. For example, the second UE quality message 1136 may comprise a measurement report and/or an indication. In some examples, the first UE 1102 may determine whether the transmission link quality satisfies (e.g., is equal to or exceeds) a minimum quality threshold to maintain a Quality of Service (QoS) of the transmission link 1110.

At 1140, the first UE 1102 modifies the unicast link with the second UE 1104 (e.g., modifies aspects of the transmission link 1110 and/or the reception link 1111) based on the reception link quality (e.g., as determined at 1130) and the transmission link quality (e.g., as determined at 1138). The first UE 1102 and the second UE 1104 may communicate using the modified unicast link, e.g., a bidirectional unicast link. In some examples, modifying an aspect of the transmission link 1110 and/or the reception link 1111 includes adjusting the timing advance of the respective link(s) 1110, 1111 to communicate data. In some examples, modifying an aspect of the transmission link 1110 and/or the reception link 1111 includes reconfiguring a QoS associated with the transmission link 1110 and/or the reception link 1111. In some examples, modifying an aspect of the transmission link 1110 and/or the reception link 1111 includes determining to switch a mode of operation. The first UE 1102 and the second UE 1104 may communicate using the modified unicast link. For example, the first UE 1102 may receive a sidelink message 1148 from the second UE 1104 using a modified reception link 1192 and/or may transmit a sidelink message 1150 to the second UE 1104 using a modified transmission link 1190.

In some examples, modifying the unicast link may include applying a determined TA adjustment. For example, at 1142, the first UE 1102 may modify the timing of the transmission link 1110 by applying the determined TA adjustment (e.g., at 1122) to form the modified transmission link 1190. The first UE 1102 may communicate data (e.g., the sidelink message 1150) with the second UE 1104 using the modified transmission link 1190. In some examples, the first UE 1102 may determine to apply the determined TA adjustment based on if the link qualities of both of the links 1110, 1111 satisfies (e.g., is equal to and/or exceeds) the respective minimum quality threshold to maintain the respective QoS. For example, the first UE 1102 may determine that the reception link quality (e.g., determined at 1130) satisfies the minimum quality threshold to maintain the QoS associated with the reception link 1111 and that the transmission link quality (e.g., determined at 1138) satisfies the minimum quality threshold to maintain the QoS associated with the transmission link 1110. In such examples, the first UE 1102 may determine to modify the timing advance of the transmission link 1110 so that the first UE 1102 transmits subsequent sidelink transmissions (e.g., the sidelink message 1150) using the modified transmission link 1190 with the TA adjustment (e.g., determined at 1122).

In some examples, modifying the unicast link may include reconfiguring the respective QoS associated with the transmission link 1110 and/or the reception link 1111. For example, at 1144, the first UE 1102 may reconfigure the QoS associated with the transmission link 1110 and/or may reconfigure the QoS associated with the reception link 1111. In some examples, the first UE 1102 may reconfigure a QoS when the link quality of the respective link 1110, 1111 fails to satisfy (e.g., is less than) the respective minimum quality threshold. For example, if the first UE 1102 determines that the reception link quality (e.g., determined at 1130) is less than the minimum quality threshold to maintain the QoS associated with the reception link 1111, the first UE 1102 may determine to reconfigure the QoS associated with the reception link 1111. In a similar manner, if the first UE 1102 determines that the transmission link quality (e.g., determined at 1138) is less than the minimum quality threshold to maintain the QoS associated with the transmission link 1110, the first UE 1102 may determine to reconfigure the QoS associated with the transmission link 1110. In some examples, reconfiguring the QoS associated with a link includes decreasing the minimum quality threshold. For example, the first UE 1102 may lower the BLER associated with the transmission link 1110 and/or the reception link 1111. In such examples, the modified transmission link 1190 and/or the modified reception link 1192 may be based on the reconfigured QoS and the determined TA adjustment (e.g., at 1122).

In some examples, modifying the bidirectional unicast link may include determining to switch a mode of operation. For example, at 1146, the first UE 1102 may determine to switch to a single-frequency full-duplex mode of operation, to switch to a sub-band full-duplex mode of operation, or to switch to a half-duplex mode of operation. When the first UE 1102 determines to switch to the single-frequency full-duplex mode of operation, the modified transmission link 1190 and the modified reception link 1192 may be associated with a same set of time-frequency resources (e.g., as described above in connection with the first example 600 and the second example 610 of FIG. 6). When the first UE 1102 determines to switch to the sub-band full-duplex mode of operation, the modified transmission link 1190 and the modified reception link 1192 may be associated with a set of time-frequency resources that are overlapping in time and non-overlapping in frequency (e.g., as described above in connection with the third example 620 of FIG. 6). When the first UE 1102 determines to switch to the half-duplex mode of operation, the modified transmission link 1190 and the modified reception link 1192 may be associated with time-frequency resources that are non-overlapping in time. In some such examples, the time-frequency resources associated with the half-duplex mode of operation may overlap in frequency. In other examples, the time-frequency resources associated with the half-duplex mode of operation may be non-overlapping in frequency.

As shown in FIG. 11, the first UE 1102 determines the timing advance to apply for bidirectional full-duplex sidelink communication. However, it may be appreciated that in some examples, the second UE 1104 may also determine the timing advance to apply for bidirectional full-duplex sidelink communication.

In some examples, the first UE 1102 may receive a request from the base station 1106 to determine the timing advance to apply for bidirectional full-duplex sidelink communication. For example, the base station 1106 may transmit a TA request 1108 that is received by the first UE 1102. The first UE 1102 may receive the TA request 1108 via a Uu interface.

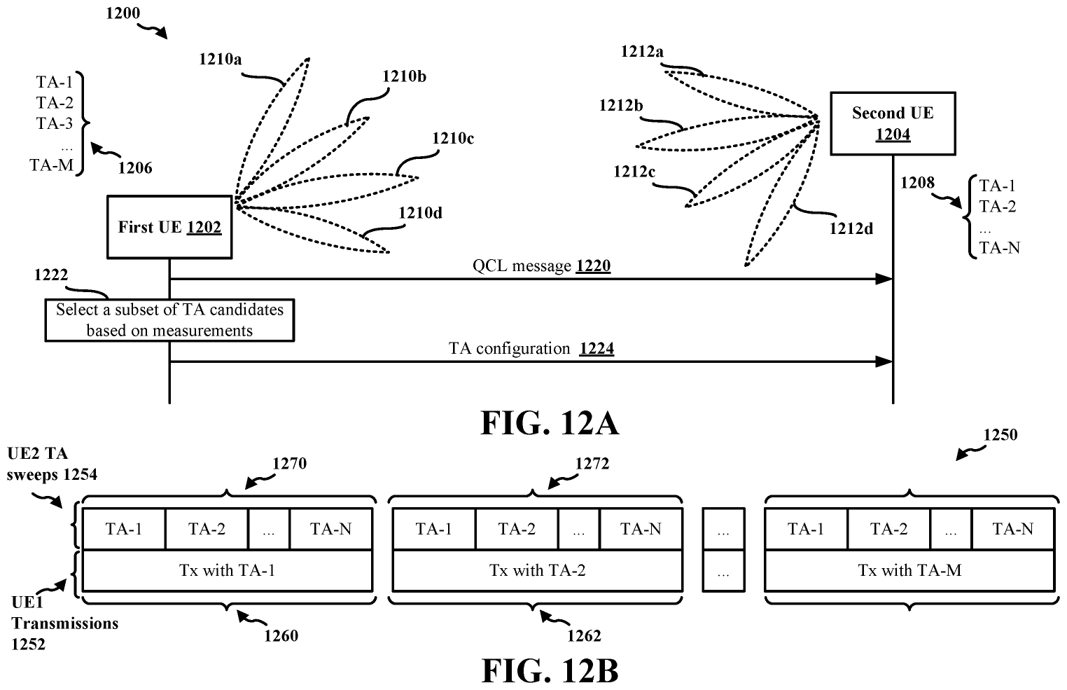

In some examples, the first UE 1102 and the second UE 1104 may perform TA training and/or refinement to determine the TA adjustment to apply. For example, at 1120, the first UE 1102 and the second UE 1104 may perform a TA training procedure to determine one or more TA values to apply. Aspects of performing the TA training procedure are described in connection with FIGS. 12A and 12B.

Although not shown in FIG. 11, it may be appreciated that in some examples, the link quality of the reception link (e.g., at 1118) may indicate that there is no clutter-interference. In other examples, the link quality of the reception link (e.g., at 1118) may indicate that the clutter-interference is manageable (e.g., less than a threshold and/or that the CP portions of the second sidelink transmission 1114 and the reflected signal 1115 overlap, at least partially, in time). In such examples, the first UE 1102 may determine to apply a TA adjustment of zero (e.g., may determine to forego adjusting the timing of the transmission link 1110).

FIG. 12A is a diagram 1200 illustrating a first UE 1202 in bidirectional full-duplex sidelink communication with a second UE 1204 performing a TA training procedure, as presented herein. The first UE 1202 may transmit sidelink transmissions 1210a, 1210b, 1210c, 1210d to the second UE 1204. The second UE 1204 may transmit sidelink transmissions 1212a, 1212b, 1212c, 1218d to the first UE 1202. FIG. 12B is a diagram 1250 illustrating a mapping of timing-adjusted transmissions while performing the TA training procedure of FIG. 12A, as presented herein. The diagram 1250 includes first UE transmissions 1252 and second UE sweeps 1254.

The first UE 1202 and/or the second UE 1204 may be configured with one or more TA candidates. The TA candidates may provide different TA values that the first UE 1202 and/or the second UE 1204 may apply when attempting to reduce the impact of the clutter-interference. For example, the first UE 1202 may be configured with a first set of TA candidates 1206 and the second UE 1204 may be configured with a second set of TA candidates 1208. One or more TA candidates of the first set of TA candidates 1206 may be the same as TA candidates of the second set of TA candidates 1208. In the illustrated example of FIGS. 12A and 12B, the first set of TA candidates 1206 includes M TA candidates and the second set of TA candidates 1208 includes N TA candidates.

The first UE 1202 may transmit a first set of sidelink transmissions 1260 to the second UE 1204. Each of the sidelink transmissions of the first set of sidelink transmissions 1260 may be associated with a same TA candidate. For example, the first set of sidelink transmissions 1260 may include N transmissions of a first sidelink transmission 1210a associated with a first TA candidate (“TA-1”) of the first set of TA candidates 1206. The second UE 1204 may sweep through different TA candidates of the second set of TA candidates 1208 to form N TA-pairs 1270 for the first TA candidate (TA-1) applied at the first UE 1202.

The first UE 1202 and the second UE 1204 may then continue repeating this process until the first UE 1202 transmits M sets of sidelink transmissions for the M different TA candidates of the first set of TA candidates 1206, where each set of the M sets of sidelink transmissions includes N transmissions associated with a same TA candidate of the first set of TA candidates 1206. For example, the first UE 1202 may transmit a second set of sidelink transmissions 1262. The second set of sidelink transmissions 1262 may include N transmissions of a second sidelink transmission 1210b associated with a second TA candidate (“TA-2”) of the first set of TA candidates 1206. The second UE 1204 may sweep through different TA candidates of the second set of TA candidates to form N TA-pairs 1272 for the second TA candidate (TA-2) applied at the first UE 1202. Based on the M TA candidates of the first set of TA candidates 1206, it may be appreciated that a total of M*N TA-pairs may be formed corresponding to the N TA-pairs formed for each of the M TA candidates of the first set of TA candidates.

In some examples, the first UE 1202 may transmit a QCL message 1220 that is received by the second UE 1204. The QCL message 1220 may indicate a QCL relationship associated with the N transmissions to the second UE 1204. For example, the QCL relationship may be with respect to a timing and a spatial configuration of the N transmissions.

At 1222, the first UE 1202 selects a subset of TA candidates based on measurements associated with the M*N TA pairs. In some examples, the subset of TA candidates may include the TA candidate with the lowest self-interference measurement. In some examples, the subset of TA candidates may include one or more TA candidates with self-interference measurements that satisfy a threshold. In some examples, the first UE 1202 may select a TA candidate from the subset of TA candidates when determining a TA adjustment to apply (e.g., at 1122 of FIG. 11).

In some examples, the first UE 1202 may transmit a TA configuration 1224 that is received by the second UE 1204. The TA configuration 1224 may indicate that the first UE 1202 is changing the TA of its transmissions. In some examples, the TA configuration 1224 may configure the second UE 1204 with time-frequency resources that the first UE 1202 intends to use for the transmissions. In some examples, the TA configuration 1224 may indicate to the second UE 1204 whether the second UE 1204 is to transmit to the first UE 1202 using the set of time-frequency resources (e.g., to operate in a single-frequency full-duplex mode). In some examples, the TA configuration 1224 may indicate to the second UE 1204 whether the second UE 1204 is to transmit to the first UE 1202 using resources overlapping in time and non-overlapping in frequency (e.g., to operate in a sub-band full-duplex mode). In some examples, the TA configuration 1224 may indicate to the second UE 1204 one or more measurements that the second UE 1204 is to report to the first UE 1202.

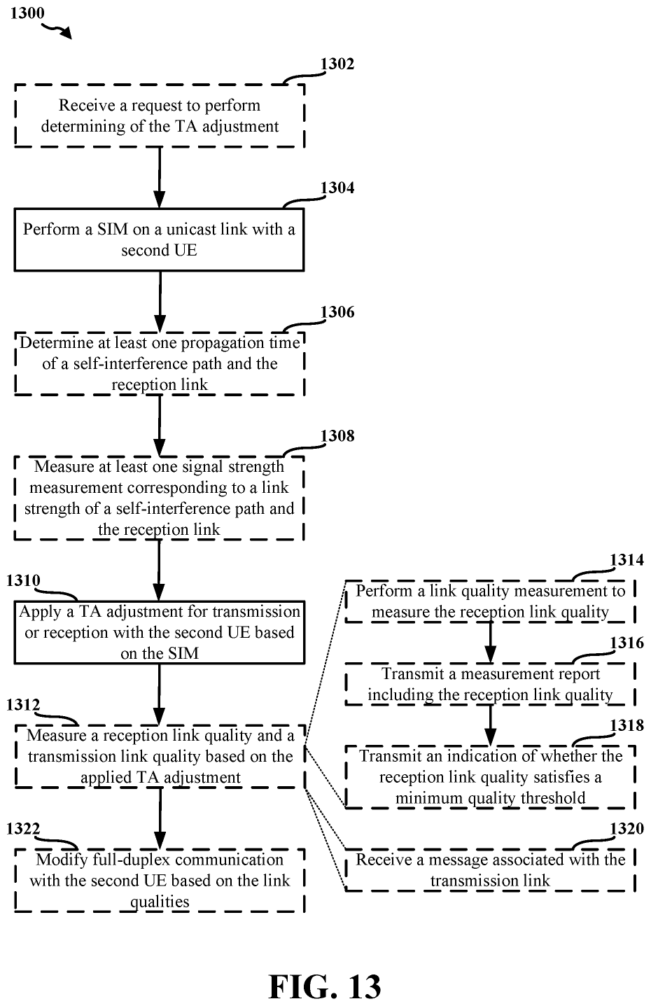

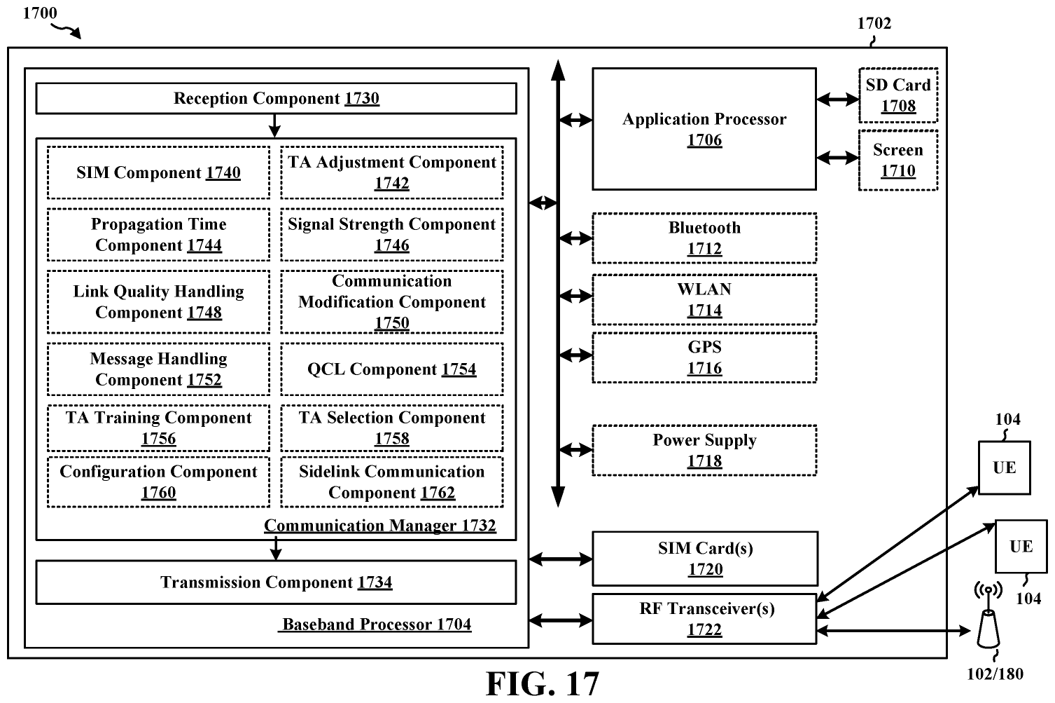

FIG. 13 is a flowchart 1300 of a method of wireless communication. The method may be performed by a sidelink device, such as a UE, an RSU, etc. For example, the method may be performed by a first UE (e.g., the UE 104, the second wireless communication device 350, and/or an apparatus 1702 of FIG. 17). Optional aspects are illustrated with a dashed line. The method may facilitate improving performance of sidelink communication, such as bidirectional full-duplex sidelink communication, by enabling the UEs to determine a TA adjustment to apply to facilitate reducing interference due to clutter-interference.

At 1304, the first UE performs a self-interference measurement on a unicast link with a second UE to determine a link quality, as described in connection with 1116 of FIG. 11. For example, 1304 may be performed by a SIM component 1740 of the apparatus 1702 of FIG. 17. The unicast link may be a bidirectional unicast link that includes a reception link for sidelink reception from the second UE and a transmission link for sidelink transmission to the second UE. In some examples, the self-interference measurement may include an SINR, a throughput measurement, and/or a reliability measurement (e.g., a BLER).

In some examples, performing the self-interference measurement includes performing the self-interference measurement on a set of time-frequency resources on which the first UE transmits one or more reference signals (e.g., when operating in a single-frequency full-duplex mode). In some examples, performing the self-interference measurement includes performing the self-interference measurement on a set of time-frequency resources on which the first UE transmits one or more reference signals, the set of time-frequency resources overlapping in a time-domain and non-overlapping a frequency-domain.

At 1310, the first UE applies a TA adjustment for transmission or reception with the second UE based on the self-interference measurement, as described in connection with 1124 of FIG. 11. For example, 1310 may be performed by a TA adjustment component 1742 of the apparatus 1702 of FIG. 17. The TA adjustment may reduce self-interference during full-duplex communication with the second UE. Thus, the UE may apply the TA adjustment during a full-duplex communication with the second UE.

In some examples, the TA adjustment applied by the first UE (e.g., at 1310) may be based on a propagation time. For example, at 1306, the first UE may determine at least one propagation time of a self-interference path and the reception link, as described in connection with the third delay 1016 and the first delay 1012 of FIG. 10. For example, 1306 may be performed by a propagation time component 1744 of the apparatus 1702 of FIG. 17. In some examples, the first UE may determine the TA adjustment that the first UE applies (e.g., at 1310) based on the at least one propagation time of the self-interference path and the reception link.

In some examples, the TA adjustment applied by the first UE (e.g., at 1310) may be based on a signal strength. For example, at 1308, the first UE may measure at least one signal strength measurement corresponding to a link strength of a self-interference path and the reception link while operating in a half-duplex mode of operation with the second UE, as described in connection with 1116 of FIG. 11. For example, 1308 may be performed by a signal strength component 1746 of the apparatus 1702 of FIG. 17. In some examples, the first UE may determine the TA adjustment that the first UE applies (e.g., at 1310) based on the at least one signal strength measurement.

At 1312, the first UE may measure a reception link quality and a transmission link quality based on the applied TA adjustment, as described in connection with 1130 and 1138 of FIG. 11. For example, 1312 may be performed by a link quality handling component 1748 of the apparatus 1702 of FIG. 17.

In some examples, at 1314, the first UE may perform a link quality measurement to measure the reception link quality, as described in connection with 1130 of FIG. 11. For example, 1314 may be performed by the link quality handling component 1748 of the apparatus 1702 of FIG. 17.

At 1316, the first UE may transmit, to the second UE, a measurement report including the reception link quality, as described in connection with the first UE quality message 1132 of FIG. 11. For example, 1316 may be performed by the link quality handling component 1748 of the apparatus 1702 of FIG. 17.

At 1318, the first UE may transmit, to the second UE, an indication of whether the reception link quality satisfies a minimum quality threshold for the reception link, as described in connection with the first UE quality message 1132 of FIG. 11. For example, 1318 may be performed by the link quality handling component 1748 of the apparatus 1702 of FIG. 17.

In some examples, at 1320, the first UE may receive, from the second UE, a message associated with the transmission link, as described in connection with the second UE quality message 1136 of FIG. 11. For example, 1320 may be performed by a message handling component 1752 of the apparatus 1702 of FIG. 17. The message may comprise a measurement report including a link quality of the transmission link. The message may include an indication of whether a link quality of the transmission link satisfies a minimum quality for the transmission link.

At 1322, the first UE may modify full-duplex communication with the second UE based on the reception link quality and the transmission link quality, as described in connection with 1140 of FIG. 11. For example, 1322 may be performed by a communication modification component 1750 of the apparatus 1702 of FIG. 17. The full-duplex communication with the second UE may comprise bidirectional full-duplex communication.

In some examples, modifying the full-duplex communication may include applying the TA adjustment for communicating data with the second UE if the reception link satisfies a reception link minimum quality threshold and the transmission link quality satisfies a transmission link minimum quality threshold, as described in connection with 1142 of FIG. 11. In some examples, modifying the full-duplex communication includes reconfiguring at least one link minimum quality threshold based on the TA adjustment, the reception link quality, and the transmission link quality, as described in connection with 1144 of FIG. 11. In some examples, modifying the full-duplex communication includes determining to switch a mode of operation for communicating with the second UE on the TA adjustment, the reception link quality, and the transmission link quality, as described in connection with 1146 of FIG. 11.

In some examples, the first UE may perform the TA adjustment determination disclosed herein based on a request received from a base station. For example, at1302, the first UE may receive, from a base station, a request to perform determining of the TA adjustment for the full-duplex communication with the second UE, as described in connection with the TA request 1108 of FIG. 11. For example, 1302 may be performed by the message handling component 1752 of the apparatus 1702 of FIG. 17.

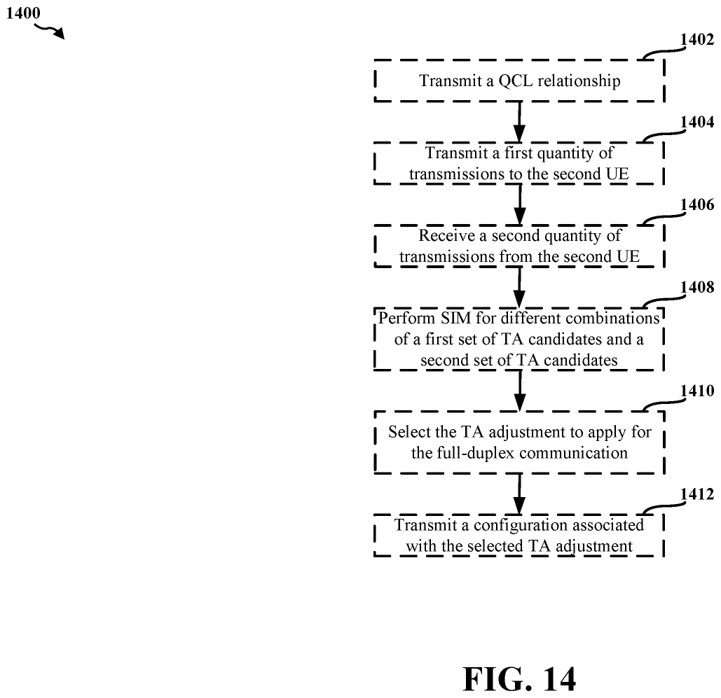

FIG. 14 is a flowchart 1400 of a method of wireless communication. The method may be performed by a sidelink device, such as a UE, an RSU, etc. For example, the method may be performed by a first UE (e.g., the UE 104, the second wireless communication device 350, and/or an apparatus 1702 of FIG. 17). Optional aspects are illustrated with a dashed line. The method may facilitate performing a TA training or refining procedure to reduce the impact of a TA adjustment on link quality, for example, while operating in a bidirectional full-duplex sidelink communication mode.

At 1402, the first UE may transmit a QCL relationship associated with N transmissions of a respective transmission set to the second UE, as described in connection with QCL message 1220 of FIG. 12A. For example, 1402 may be performed by a QCL component 1754 of the apparatus 1702 of FIG. 17. In some examples, the QCL relationship may be with respect to a timing and a spatial configuration of the N transmissions.

At 1404, the first UE may transmit a first quantity of transmissions to the second UE, as described in connection with the first UE transmissions 1252 of FIG. 12B. For example, 1404 may be performed by a TA training component 1756 of the apparatus 1702 of FIG. 17. The first quantity of transmissions may include M transmission sets, each transmission set of the M transmission sets associated with a first set of TA candidates of the first UE, and each transmission set of the M transmission sets including N transmissions associated with a same TA candidate of the first set of TA candidates.

At 1406, the first UE may receive a second quantity of transmissions from the second UE, as described in connection with the second UE sweeps 1254 of FIG. 12B. For example, 1406 may be performed by the TA training component 1756 of the apparatus 1702 of FIG. 17. The second quantity of transmissions may include M transmission sets, each transmission set of the M transmission sets including N transmissions associated with a different TA candidate of a second set of TA candidates of the second UE.

At 1408, the first UE may perform self-interference measurements for different combinations of the first set of TA candidates of the first UE and the second set of TA candidates of the second UE, as described in connection with 1222 of FIG. 12A. For example, 1408 may be performed by a SIM component 1740 of the apparatus 1702 of FIG. 17.

At 1410, the first UE may select the TA adjustment to apply for the full-duplex communication with the second UE based on the self-interference measurements for the different combinations, as described in connection with 1222 of FIG. 12A. For example, 1410 may be performed by a TA selection component 1758 of the apparatus 1702 of FIG. 17. In some examples, the selected TA adjustment may correspond to a lowest self-interference measurement.

At 1412, the first UE may transmit a configuration associated with the selected TA adjustment to the second UE, as described in connection with the TA configuration 1224 of FIG. 12A. For example, 1412 may be performed by a configuration component 1760 of the apparatus 1702 of FIG. 17. The configuration may include an indication of a set of time-frequency resources of transmissions associated with the selected TA adjustment. The configuration may include an indication of whether the second UE is to transmit to the first UE using the set of time-frequency resources. The configuration may include an indication of whether the second UE is to transmit to the first UE using resources overlapping in a time-domain and non-overlapping in a frequency-domain. The configuration may include an indication of one or more measurements to report to the first UE.

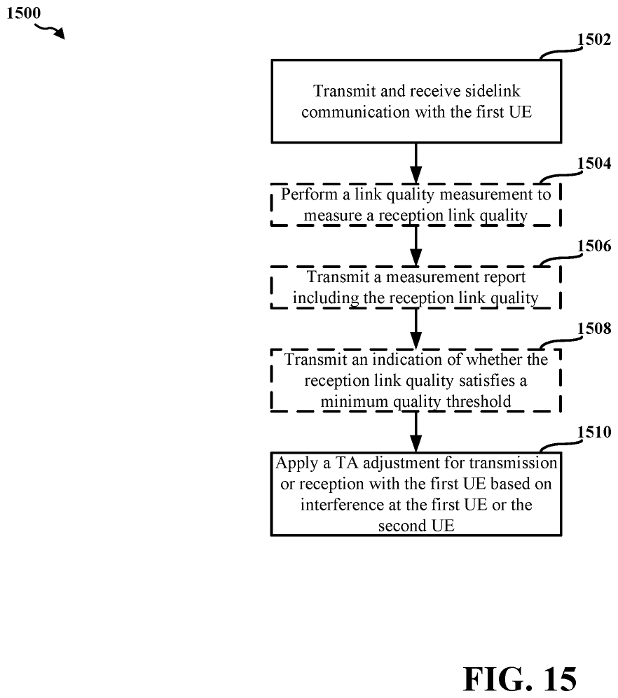

FIG. 15 is a flowchart 1500 of a method of wireless communication with a first UE at a second UE. The method may be performed by a sidelink device, such as a UE, an RSU, etc. For example, the method may be performed by a second UE (e.g., the UE 104, the second wireless communication device 350, and/or an apparatus 1702 of FIG. 17). Optional aspects are illustrated with a dashed line. The method may facilitate improving performance of sidelink communication by enabling the UEs to determine a TA adjustment to apply to facilitate reducing interference due to clutter-interference. The aspects may improve full-duplex sidelink communication on a bidirectional link between two UEs, for example.

At 1502, the second UE transmits and receives sidelink communication with the first UE in a full-duplex mode on a unicast link, as described in connection with the sidelink transmissions 1112, 1114 of FIG. 11. For example, 1502 may be performed by a sidelink communication component 1762 of the apparatus 1702 of FIG. 17. The unicast link may be a bidirectional unicast link that includes a reception link for sidelink reception from the first UE, and a transmission link for sidelink transmission to the second UE.

At 1504, the second UE may perform a link quality measurement to determine a reception link quality, as described in connection with 1134 of FIG. 11. For example, 1504 may be performed by the link quality handling component 1748 of the apparatus 1702 of FIG. 17.

At 1506, the second UE may transmit, to the first UE, a measurement report including the reception link quality, as described in connection with the second UE quality message 1136 of FIG. 11. For example, 1506 may be performed by the link quality handling component 1748 of the apparatus 1702 of FIG. 17.

At 1508, the second UE may transmit, to the first UE, an indication of whether the reception link quality satisfies a minimum quality threshold for the reception link, as described in connection with the second UE quality message 1136 of FIG. 11. For example, 1508 may be performed by the link quality handling component 1748 of the apparatus 1702 of FIG. 17.

At 1510, the second UE applies a TA adjustment for transmission or reception with the first UE based on interference at the first UE or the second UE, as described in connection with 1140 of FIG. 11. For example, 1510 may be performed by the TA adjustment component 1742 of the apparatus 1702 of FIG. 17.

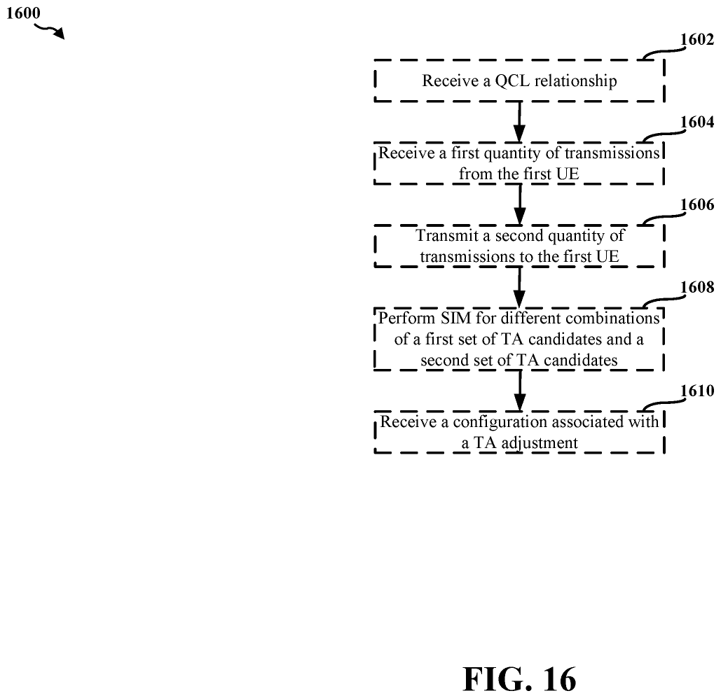

FIG. 16 is a flowchart 1600 of a method of wireless communication with a first UE at a second UE. The method may be performed by a sidelink device, such as a UE, an RSU, etc. For example, the method may be performed by a second UE (e.g., the UE 104, the second wireless communication device 350, and/or an apparatus 1702 of FIG. 17). Optional aspects are illustrated with a dashed line. The method may facilitate performing a TA training or refining procedure to reduce the impact of a TA adjustment on link quality. Aspects may reduce interference for communication exchange on a bidirectional full-duplex link for sidelink communication.

At 1602, the second UE may receive a QCL relationship associated with N transmissions of a respective transmission set from the first UE, as described in connection with QCL message 1220 of FIG. 12A. For example, 1602 may be performed by the QCL component 1754 of the apparatus 1702 of FIG. 17. In some examples, the QCL relationship may be with respect to a timing and a spatial configuration of the N transmissions.

At 1604, the second UE may receive a first quantity of transmissions from the first UE, as described in connection with the first UE transmissions 1252 of FIG. 12B. For example, 1604 may be performed by a TA training component 1756 of the apparatus 1702 of FIG. 17. The first quantity of transmissions may include M transmission sets, each transmission set of the M transmission sets associated with a first set of TA candidates of the first UE, and each transmission set of the M transmission sets including N transmissions associated with a same TA candidate of the first set of TA candidates.

At 1606, the second UE may transmit a second quantity of transmissions to the first UE, as described in connection with the second UE sweeps 1254 of FIG. 12B. For example, 1606 may be performed by the TA training component 1756 of the apparatus 1702 of FIG. 17. The second quantity of transmissions may include M transmission sets, each transmission set of the M transmission sets including N transmissions associated with a different TA candidate of a second set of TA candidates of the second UE.

At 1608, the second UE may perform self-interference measurements for different combinations of the first set of TA candidates of the first UE and the second set of TA candidates of the second UE, as described in connection with 1222 of FIG. 12A. For example, 1608 may be performed by a SIM component 1740 of the apparatus 1702 of FIG. 17.

At 1610, the second UE may receive a configuration associated with a TA adjustment from the first UE, as described in connection with the TA configuration 1224 of FIG. 12A. For example, 1610 may be performed by a configuration component 1760 of the apparatus 1702 of FIG. 17. The configuration may include an indication of a set of time-frequency resources of transmissions associated with the selected TA adjustment. The configuration may include an indication of whether the second UE is to transmit to the first UE using the set of time-frequency resources. The configuration may include an indication of whether the second UE is to transmit to the first UE using resources overlapping in a time-domain and non-overlapping in a frequency-domain. The configuration may include an indication of one or more measurements to report to the first UE.

FIG. 17 is a diagram 1700 illustrating an example of a hardware implementation for an apparatus 1702. The apparatus 1702 is a sidelink device, such as a UE and includes a baseband processor 1704 (also referred to as a modem) coupled to a RF transceiver 1722 and one or more subscriber identity modules (SIM) cards 1720, an application processor 1706 coupled to a secure digital (SD) card 1708 and a screen 1710, a Bluetooth module 1712, a wireless local area network (WLAN) module 1714, a Global Positioning System (GPS) module 1716, and a power supply 1718. The baseband processor 1704 communicates through the RF transceiver 1722 with the UE 104 and/or BS 102/180. In some examples, the baseband processor 1704 may comprise a cellular baseband processor, and the RF transceiver 1722 may comprise a cellular RF transceiver. The baseband processor 1704 may include a computer-readable medium/memory. The computer-readable medium/memory may be non-transitory. The baseband processor 1704 is responsible for general processing, including the execution of software stored on the computer-readable medium/memory. The software, when executed by the baseband processor 1704, causes the baseband processor 1704 to perform the various functions described supra. The computer-readable medium/memory may also be used for storing data that is manipulated by the baseband processor 1704 when executing software. The baseband processor 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the baseband processor 1704. The baseband processor 1704 may be a component of the second wireless communication device 350 and may include the memory 360 and/or at least one of the TX processor 368, the RX processor 356, and the controller/processor 359. In one configuration, the apparatus 1702 may be a modem chip and include just the baseband processor 1704, and in another configuration, the apparatus 1702 may be the entire wireless device (e.g., see the second wireless communication device 350 of FIG. 3) and include the additional modules of the apparatus 1702.

The communication manager 1732 includes a SIM component 1740 that is configured to perform a self-interference measurement on a unicast link, such as a bidirectional unicast link, with a second UE to determine a link quality, for example, as described in connection with 1304 of FIG. 13. The example SIM component 1740 may also be configured to perform self-interference measurements for different combinations of the first set of TA candidates of the first UE and the second set of TA candidates of the second UE, for example, as described in connection with 1408 of FIG. 14. The example SIM component 1740 may also be configured to perform self-interference measurements for different combinations of the first set of TA candidates of the first UE and the second set of TA candidates of the second UE, for example, as described in connection with 1608 of FIG. 16.

The communication manager 1732 also includes a TA adjustment component 1742 that is configured to apply a TA adjustment for transmission or reception with the second UE based on the self-interference measurement, for example, as described in connection with 1310 of FIG. 13. The example TA adjustment component 1742 may also be configured to apply a TA adjustment for transmission or reception with the first UE based on interference at the first UE or the second UE, for example, as described in connection with 1510 of FIG. 15.

The communication manager 1732 also includes a propagation time component 1744 that is configured to determine at least one propagation time of a self-interference path and the reception link, for example, as described in connection with 1306 of FIG. 13.

The communication manager 1732 also includes a signal strength component 1746 that is configured to measure at least one signal strength measurement corresponding to a link strength of a self-interference path and the reception link while operating in a half-duplex mode of operation with the second UE, for example, as described in connection with 1308 of FIG. 13.

The communication manager 1732 also includes a link quality handling component 1748 that is configured to measure a reception link quality and a transmission link quality based on the applied TA adjustment, for example, as described in connection with 1312 of FIG. 13. The example link quality handling component 1748 may also be configured to perform a link quality measurement to measure the reception link quality, for example, as described in connection with 1314 of FIG. 13. The example link quality handling component 1748 may also be configured to transmit, to the second UE, a measurement report including the reception link quality, for example, as described in connection with 1316 of FIG. 13. The example link quality handling component 1748 may also be configured to transmit, to the second UE, an indication of whether the reception link quality satisfies a minimum quality threshold for the reception link, for example, as described in connection with 1318 of FIG. 13. The example link quality handling component 1748 may also be configured to perform a link quality measurement to determine a reception link quality, for example, as described in connection with 1504 of FIG. 15. The example link quality handling component 1748 may also be configured to transmit, to the first UE, a measurement report including the reception link quality, for example, as described in connection with 1506 of FIG. 15. The example link quality handling component 1748 may also be configured to transmit, to the first UE, an indication of whether the reception link quality satisfies a minimum quality threshold for the reception link, as described in connection with 1508 of FIG. 15.

The communication manager 1732 also includes a communication modification component 1750 that is configured to modify full-duplex communication with the second UE based on the reception link quality and the transmission link quality, for example, as described in connection with 1322 of FIG. 13.

The communication manager 1732 also includes a message handling component 1752 that is configured to receive, from the second UE, a message associated with the transmission link, for example, as described in connection with 1320 of FIG. 13. The example message handling component 1752 may also be configured to receive, from a base station, a request to perform determining of the TA adjustment for the full-duplex communication with the second UE, for example, as described in connection with 1302 of FIG. 13.

The communication manager 1732 also includes a QCL component 1754 that is configured to transmit a QCL relationship associated with N transmissions of a respective transmission set to the second UE, for example, as described in connection with 1402 of FIG. 14. The example QCL component 1754 may also be configured to receive a QCL relationship associated with N transmissions of a respective transmission set from the first UE, for example, as described in connection with 1602 of FIG. 16.

The communication manager 1732 also includes a TA training component 1756 that is configured to transmit a first quantity of transmissions to the second UE, for example, as described in connection with 1404 of FIG. 14. The example TA training component 1756 may also be configured to receive a second quantity of transmissions from the second UE, for example, as described in connection with 1406 of FIG. 14. The example TA training component 1756 may also be configured to receive a first quantity of transmissions from the first UE, for example, as described in connection 1604 of FIG. 16. The example TA training component 1756 may also be configured to transmit a second quantity of transmissions to the first UE, for example, as described in connection with 1606 of FIG. 16.

The communication manager 1732 also includes a TA selection component 1758 that is configured to select the TA adjustment based on the self-interference measurements for the different combinations, for example, as described in connection with 1410 of FIG. 14.

The communication manager 1732 also includes a configuration component 1760 that is configured to transmit a configuration associated with the selected TA adjustment to the second UE, for example, as described in connection with 1412 of FIG. 14. The example configuration component 1760 may also be configured to receive a configuration associated with a TA adjustment from the first UE, for example, as described in connection with 1610 of FIG. 16.

The communication manager 1732 may also include a sidelink communication component 1762 that is configured to transmit and receive sidelink communication with the first UE in a full-duplex mode on a bidirectional unicast link, for example, as described in connection with 1502 of FIG. 15.

The apparatus may include additional components that perform each of the blocks of the algorithm in the aforementioned flowcharts of FIGS. 13, 14, 15, and/or 16. As such, each block in the aforementioned flowcharts of FIGS. 13, 14, 15, and/or 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1702, and in particular the cellular baseband processor 1704, includes means for performing a self-interference measurement on a unicast link with a second UE to determine a link quality. The example apparatus 1702 also includes means for applying a timing advance (TA) adjustment for transmission or reception with the second UE based on the self-interference measurement, for example, during a full-duplex communication with the second UE.

In another configuration, the example apparatus 1702 also includes means for performing the self-interference measurement on a set of time-frequency resources on which the first UE transmits one or more reference signals.

In another configuration, the example apparatus 1702 also includes means for performing the self-interference measurement on a set of time-frequency resources on which the first UE transmits one or more reference signals, the set of time-frequency resources overlapping in a time-domain and non-overlapping in a frequency-domain.

In another configuration, the example apparatus 1702 also includes means for determining at least one propagation time of a self-interference path and the reception link.

In another configuration, the example apparatus 1702 also includes means for measuring at least one signal strength measurement corresponding to a link strength of a self-interference path and the reception link, for example, for operation in a half-duplex mode of operation with the second UE.

In another configuration, the example apparatus 1702 also includes means for measuring a reception link quality and a transmission link quality based on the applied TA adjustment. The example apparatus 1702 also includes means for modifying full-duplex communication with the second UE based on the reception link quality and the transmission link quality.

In another configuration, the example apparatus 1702 also includes means for performing a link quality measurement to measure the reception link quality.

In another configuration, the example apparatus 1702 also includes means for transmitting, to the second UE, a measurement report including the reception link quality.

In another configuration, the example apparatus 1702 also includes means for transmitting, to the second UE, an indication of whether the reception link quality satisfies a minimum quality threshold for the reception link.

In another configuration, the example apparatus 1702 also includes means for receiving, from the second UE, a message associated with the transmission link.

In another configuration, the example apparatus 1702 also includes means for applying the TA adjustment for communicating data with the second UE if the reception link quality satisfies a reception link minimum quality threshold and the transmission link quality satisfies a transmission link minimum quality threshold.

In another configuration, the example apparatus 1702 also includes means for reconfiguring at least one link minimum quality threshold based on the TA adjustment, the reception link quality, and the transmission link quality.

In another configuration, the example apparatus 1702 also includes means for determining to switch a mode of operation for communicating with the second UE on the TA adjustment, the reception link quality, and the transmission link quality.

In another configuration, the example apparatus 1702 also includes means for receiving, from a base station, a request to perform determining of the TA adjustment for the full-duplex communication with the second UE.

In another configuration, the example apparatus 1702 also includes means for transmitting a first quantity of transmissions to the second UE, the first quantity of transmissions including M transmission sets, each transmission set of the M transmission sets associated with a first set of TA candidates of the first UE, and each transmission set of the M transmission sets including N transmissions associated with a same TA candidate of the first set of TA candidates. The example apparatus 1702 also includes means for receiving a second quantity of transmissions from the second UE, the second quantity of transmissions including M transmission sets, each transmission set of the M transmission sets including N transmissions associated with a different TA candidate of a second set of TA candidates of the second UE. The example apparatus 1702 also includes means for performing self-interference measurements for different combinations of the first set of TA candidates of the first UE and the second set of TA candidates of the second UE. The example apparatus 1702 also includes means for selecting the TA adjustment to apply with the second UE based on the self-interference measurements for the different combinations.

In another configuration, the example apparatus 1702 also includes means for transmitting a quasi co-location (QCL) relationship associated with the N transmissions of a respective transmission set to the second UE.

In another configuration, the example apparatus 1702 also includes means for transmitting a configuration associated with the selected TA adjustment to the second UE.

In another configuration, the example apparatus 1702 also includes means for transmitting and receiving sidelink communication with the first UE in a full-duplex mode on a unicast link. The example apparatus 1702 also includes means for applying a timing advance (TA) adjustment for transmission or reception of the sidelink communication with the first UE, the TA adjustment being based on interference at the first UE or the second UE.

In another configuration, the example apparatus 1702 also includes means for performing a link quality measurement to determine a reception link quality.

In another configuration, the example apparatus 1702 also includes means for transmitting, to the first UE, a measurement report including the reception link quality.

In another configuration, the example apparatus 1702 also includes means for transmitting, to the first UE, an indication of whether the reception link quality satisfies a minimum quality threshold for the reception link.

In another configuration, the example apparatus 1702 also includes means for receiving a first quantity of transmissions from the first UE, the first quantity of transmissions including M transmission sets, each transmission set of the M transmission sets associated with a first set of TA candidates of the first UE, and each transmission set of the M transmission sets including N transmissions associated with a same TA candidate of the first set of TA candidates. The example apparatus 1702 also includes means for transmitting a second quantity of transmissions to the first UE, the second quantity of transmissions including M transmission sets, each transmission set of the M transmission sets including N transmissions associated with a different TA candidate of a second set of TA candidates of the second UE. The example apparatus 1702 also includes means for performing self-interference measurements for different combinations of the first set of TA candidates of the first UE and the second set of TA candidates of the second UE.

In another configuration, the example apparatus 1702 also includes means for receiving a quasi co-location (QCL) relationship associated with the N transmissions of a respective transmission set from the first UE.

In another configuration, the example apparatus 1702 also includes means for receiving a configuration associated with a TA adjustment from the first UE.

The aforementioned means may be one or more of the aforementioned components of the apparatus 1702 configured to perform the functions recited by the aforementioned means. As described supra, the apparatus 1702 may include the TX processor 368, the RX processor 356, and the controller/processor 359. As such, in one configuration, the aforementioned means may be the TX processor 368, the RX processor 356, and the controller/processor 359 configured to perform the functions recited by the aforementioned means.

Aspects disclosed herein provide techniques for determining a TA adjustment at the first UE and the second UE based on the coupling of the reception timing associated with bidirectional full-duplex sidelink communication. For example, aspects disclosed herein facilitate determining a TA adjustment for a transmission link and/or a reception link so that the CP portions of a signal and a reflected signal overlap, at least partially, in time. As a result, the self-interference due to the reception of the reflected signal may be managed (or ignored) and the performance of the bidirectional full-duplex sidelink communication is not degraded.

In some examples, the first UE and the second UE may perform TA training and/or refinement to determine a TA adjustment to apply. Aspects disclosed herein may facilitate performing a TA training or refining procedure to reduce the impact of a TA adjustment on link quality while operating in a bidirectional full-duplex sidelink communication mode.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a first UE, comprising: performing a self-interference measurement on a unicast link with a second UE to determine a link quality; and applying a timing advance (TA) adjustment for transmission or reception with the second UE based on the self-interference measurement.

Aspect 2 is the method of aspect 1, further including that the TA adjustment is applied for full-duplex communication with the second UE, and the unicast link is a bidirectional link that includes: a reception link for sidelink reception from the second UE, and a transmission link for sidelink transmission to the second UE.

Aspect 3 is the method of any of aspect 1 or aspect 2, further including that the self-interference measurement includes one or more of: a signal-to-interference-to-noise ratio (SINR), a throughput measurement, or a reliability measurement.

Aspect 4 is the method of any of aspects 1 to 3, further including that performing the self-interference measurement further includes performing the self-interference measurement on a set of time-frequency resources on which the first UE transmits one or more reference signals.

Aspect 5 is the method of any of aspects 1 to 4, further including that performing the self-interference measurement further includes performing the self-interference measurement on a set of time-frequency resources on which the first UE transmits one or more reference signals, the set of time-frequency resources overlapping in a time-domain and non-overlapping in a frequency-domain.

Aspect 6 is the method of any of aspects 1 to 5, further including: determining at least one propagation time of a self-interference path and the reception link, and wherein the TA adjustment is further based on the at least one propagation time of the self-interference path and the reception link.

Aspect 7 is the method of any of aspects 1 to 6, further including that performing the self-interference measurement further includes measuring at least one signal strength measurement corresponding to a link strength of a self-interference path and the reception link while operating in a half-duplex mode of operation with the second UE, and wherein the TA adjustment is based on the at least one signal strength measurement.

Aspect 8 is the method of any of aspects 1 to 7, further including: measuring a reception link quality and a transmission link quality based on the applied TA adjustment; and modifying full-duplex communication with the second UE based on the reception link quality and the transmission link quality.

Aspect 9 is the method of any of aspects 1 to 8, further including: performing a link quality measurement to measure the reception link quality.

Aspect 10 is the method of any of aspects 1 to 9, further including: transmitting, to the second UE, a measurement report including the reception link quality.

Aspect 11 is the method of any of aspects 1 to 10, further including: transmitting, to the second UE, an indication of whether the reception link quality satisfies a minimum quality threshold for the reception link.

Aspect 12 is the method of any of aspects 1 to 11, further including: receiving, from the second UE, a message associated with the transmission link.

Aspect 13 is the method of any of aspects 1 to 12, further including that the message comprises a measurement report including a link quality of the transmission link.

Aspect 14 is the method of any of aspects 1 to 13, further including that the message includes an indication of whether a link quality of the transmission link satisfies a minimum quality threshold for the transmission link.

Aspect 15 is the method of any of aspects 1 to 14, further including that modifying the full-duplex communication further includes applying the TA adjustment for communicating data with the second UE if the reception link quality satisfies a reception link minimum quality threshold and the transmission link quality satisfies a transmission link minimum quality threshold.

Aspect 16 is the method of any of aspects 1 to 15, further including that modifying the full-duplex communication further includes reconfiguring at least one link minimum quality threshold based on the TA adjustment, the reception link quality, and the transmission link quality.

Aspect 17 is the method of any of aspects 1 to 16, further including that modifying the full-duplex communication further includes determining to switch a mode of operation for communicating with the second UE on the TA adjustment, the reception link quality, and the transmission link quality.

Aspect 18 is the method of any of aspects 1 to 17, further including: receiving, from a base station, a request to perform determining of the TA adjustment for the full-duplex communication with the second UE.

Aspect 19 is the method of any of aspects 1 to 18, further including: transmitting a first quantity of transmissions to the second UE, the first quantity of transmissions including M transmission sets, each transmission set of the M transmission sets associated with a first set of TA candidates of the first UE, and each transmission set of the M transmission sets including N transmissions associated with a same TA candidate of the first set of TA candidates; receiving a second quantity of transmissions from the second UE, the second quantity of transmissions including M transmission sets, each transmission set of the M transmission sets including N transmissions associated with a different TA candidate of a second set of TA candidates of the second UE; performing self-interference measurements for different combinations of the first set of TA candidates of the first UE and the second set of TA candidates of the second UE; and selecting the TA adjustment to apply for the full-duplex communication with the second UE based on the self-interference measurements for the different combinations.

Aspect 20 is the method of any of aspects 1 to 19, further including that the selected TA adjustments corresponds to a lowest self-interference measurement.

Aspect 21 is the method of any of aspects 1 to 20, further including: transmitting a quasi co-location (QCL) relationship associated with the N transmissions of a respective transmission set to the second UE.

Aspect 22 is the method of any of aspects 1 to 21, further including that the QCL relationship is with respect to a timing and a spatial configuration of the N transmissions.

Aspect 23 is the method of any of aspects 1 to 22, further including: transmitting a configuration associated with the selected TA adjustment to the second UE.

Aspect 24 is the method of any of aspects 1 to 23, further including that the configuration includes one or more of: an indication of a set of time-frequency resources of transmissions associated with the selected TA adjustment, an indication of whether the second UE is to transmit to the first UE using the set of time-frequency resources, an indication of whether the second UE is to transmit to the first UE using resources overlapping in a time-domain and non-overlapping in a frequency-domain, or an indication of one or more measurements to report to the first UE.

Aspect 25 is an apparatus for wireless communication including a memory and at least one processor coupled to a memory, the memory and the at least one processor configured to implement a method as in any of aspects 1 to 24.

Aspect 26 is an apparatus for wireless communication including means for implementing a method as in any of aspects 1 to 24.

Aspect 27 is a non-transitory computer-readable storage medium storing computer executable code, where the code, when executed, causes a processor to implement a method as in any of aspects 1 to 24.

Aspect 28 is a method of wireless communication with a first user equipment (UE) at a second UE, the method comprising: transmitting and receiving sidelink communication with the first UE in a full-duplex mode on a unicast link; and applying a timing advance (TA) adjustment for transmission or reception of the sidelink communication with the first UE, the TA adjustment being based on interference at the first UE or the second UE.

Aspect 29 is the method of aspect 28, further including that the unicast link is a bidirectional unicast link that includes: a reception link for sidelink reception from the first UE, and a transmission link for sidelink transmission to the first UE.

Aspect 30 is the method of any of aspect 28 or aspect 29, further including: performing a link quality measurement to determine a reception link quality.

Aspect 31 is the method of any of aspects 28 to 30, further including: transmitting, to the first UE, a measurement report including the reception link quality.

Aspect 32 is the method of any of aspects 28 to 31, further including: transmitting, to the first UE, an indication of whether the reception link quality satisfies a minimum quality threshold for the reception link.

Aspect 33 is the method of any of aspects 28 to 32, further including: receiving a first quantity of transmissions from the first UE, the first quantity of transmissions including M transmission sets, each transmission set of the M transmission sets associated with a first set of TA candidates of the first UE, and each transmission set of the M transmission sets including N transmissions associated with a same TA candidate of the first set of TA candidates; transmitting a second quantity of transmissions to the first UE, the second quantity of transmissions including M transmission sets, each transmission set of the M transmission sets including N transmissions associated with a different TA candidate of a second set of TA candidates of the second UE; and performing self-interference measurements for different combinations of the first set of TA candidates of the first UE and the second set of TA candidates of the second UE.

Aspect 34 is the method of any of aspects 28 to 33, further including: receiving a quasi co-location (QCL) relationship associated with the N transmissions of a respective transmission set from the first UE.

Aspect 35 is the method of any of aspects 28 to 34, further including that the QCL relationship is with respect to a timing and a spatial configuration of the N transmissions.

Aspect 36 is the method of any of aspects 28 to 35, further including: receiving a configuration associated with a TA adjustment from the first UE.

Aspect 37 is the method of any of aspects 28 to 36, further including that the configuration includes one or more of: an indication of a set of time-frequency resources of transmissions associated with the TA adjustment from the first UE, an indication of whether to transmit to the first UE using the set of time-frequency resources, an indication of whether to transmit to the first UE using resources overlapping in a time-domain and non-overlapping in a frequency-domain, or an indication of one or more measurements to report to the first UE.

Aspect 38 is an apparatus for wireless communication including a memory and at least one processor coupled to a memory, the memory and the at least one processor configured to implement a method as in any of aspects 28 to 37.

Aspect 39 is an apparatus for wireless communication including means for implementing a method as in any of aspects 28 to 37.

Aspect 40 is a non-transitory computer-readable storage medium storing computer executable code, where the code, when executed, causes a processor to implement a method as in any of aspects 28 to 37.

What is claimed is:

1. An apparatus for wireless communication at a first UE, comprising:
a memory; and
at least one processor coupled to the memory, the memory and the at least one processor configured to:
perform a self-interference measurement on a unicast link with a second UE to determine a link quality; and
apply a timing advance (TA) adjustment for transmission or reception with the second UE based on the self-interference measurement.

2. The apparatus of claim 1, wherein the TA adjustment is applied for full-duplex communication with the second UE, and the unicast link is a bidirectional link that includes:
a reception link for sidelink reception from the second UE, and
a transmission link for sidelink transmission to the second UE.

3. The apparatus of claim 2, wherein the self-interference measurement includes one or more of:
a signal-to-interference-to-noise ratio (SINK),
a throughput measurement, or
a reliability measurement.

4. The apparatus of claim 2, wherein to perform the self-interference measurement, the memory and the at least one processor are configured to perform the self-interference measurement on a set of time-frequency resources on which the first UE transmits one or more reference signals.

5. The apparatus of claim 2, wherein to perform the self-interference measurement, the memory and the at least one processor are configured to perform the self-interference measurement on a set of time-frequency resources on which the first UE transmits one or more reference signals, the set of time-frequency resources overlapping in a time-domain and non-overlapping in a frequency-domain.

6. The apparatus of claim 2, wherein the memory and the at least one processor are further configured to:
determine at least one propagation time of a self-interference path and the reception link, and
wherein the TA adjustment is further based on the at least one propagation time of the self-interference path and the reception link.

7. The apparatus of claim 2, wherein to perform the self-interference measurement, the memory and the at least one processor are configured to measure at least one signal strength measurement corresponding to a link strength of a self-interference path and the reception link while operating in a half-duplex mode of operation with the second UE, and
wherein the TA adjustment is based on the at least one signal strength measurement.

8. The apparatus of claim 2, wherein the memory and the at least one processor are further configured to:
measure a reception link quality and a transmission link quality based on the applied TA adjustment; and
modify full-duplex communication with the second UE based on the reception link quality and the transmission link quality.

9. The apparatus of claim 8, wherein the memory and the at least one processor are further configured to:
perform a link quality measurement to measure the reception link quality; and
transmit, to the second UE, a measurement report including the reception link quality.

10. The apparatus of claim 8, wherein the memory and the at least one processor are further configured to:
perform a link quality measurement to measure the reception link quality; and
transmit, to the second UE, an indication of whether the reception link quality satisfies a minimum quality threshold for the reception link.

11. The apparatus of claim 8, wherein the memory and the at least one processor are further configured to:
receive, from the second UE, a message associated with the transmission link, the message comprising a measurement report including a link quality of the transmission link.

12. The apparatus of claim 8, wherein the memory and the at least one processor are further configured to:
receive, from the second UE, a message associated with the transmission link, the message including an indication of whether a link quality of the transmission link satisfies a minimum quality threshold for the transmission link.

13. The apparatus of claim 8, wherein to modify the full-duplex communication, the memory and the at least one processor are configured to apply the TA adjustment for communicating data with the second UE if the reception link quality satisfies a reception link minimum quality threshold and the transmission link quality satisfies a transmission link minimum quality threshold.

14. The apparatus of claim 8, wherein to modify the full-duplex communication, the memory and the at least one processor are configured to reconfigure at least one link minimum quality threshold based on the TA adjustment, the reception link quality, and the transmission link quality.

15. The apparatus of claim 8, wherein to modify the full-duplex communication, the memory and the at least one processor are configured to switch a mode of operation for communicating with the second UE on the TA adjustment, the reception link quality, and the transmission link quality.

16. The apparatus of claim 2, wherein the memory and the at least one processor are further configured to:
receive, from a base station, a request to perform determining of the TA adjustment for the full-duplex communication with the second UE.

17. The apparatus of claim 2, wherein the memory and the at least one processor are further configured to:
transmit a first quantity of transmissions to the second UE, the first quantity of transmissions including M transmission sets, each transmission set of the M transmission sets associated with a first set of TA candidates of the first UE, and each transmission set of the M transmission sets including N transmissions associated with a same TA candidate of the first set of TA candidates;
receive a second quantity of transmissions from the second UE, the second quantity of transmissions including M transmission sets, each transmission set of the M transmission sets including N transmissions associated with a different TA candidate of a second set of TA candidates of the second UE;
perform self-interference measurements for different combinations of the first set of TA candidates of the first UE and the second set of TA candidates of the second UE; and
select the TA adjustment to apply for the full-duplex communication with the second UE based on the self-interference measurements for the different combinations.

18. The apparatus of claim 17, wherein the selected TA adjustment corresponds to a lowest self-interference measurement.

19. The apparatus of claim 17, wherein the memory and the at least one processor are further configured to:
transmit a quasi co-location (QCL) relationship associated with the N transmissions of a respective transmission set to the second UE, the QCL relationship being with respect to a timing and a spatial configuration of the N transmissions.

20. The apparatus of claim 17, wherein the memory and the at least one processor are further configured to:
transmit a configuration associated with the selected TA adjustment to the second UE, the configuration including one or more of:
an indication of a set of time-frequency resources of transmissions associated with the selected TA adjustment,
an indication of whether the second UE is to transmit to the first UE using the set of time-frequency resources,
an indication of whether the second UE is to transmit to the first UE using resources overlapping in a time-domain and non-overlapping in a frequency-domain, or
an indication of one or more measurements to report to the first UE.

21. A method of wireless communication at a first UE, comprising:
performing a self-interference measurement on a unicast link with a second UE to determine a link quality; and
applying a timing advance (TA) adjustment for transmission or reception with the second UE based on the self-interference measurement.

22. An apparatus for wireless communication with a first user equipment (UE) at a second UE, comprising:
a memory; and
at least one processor coupled to the memory, the memory and the at least one processor configured to:
transmit and receive sidelink communication with the first UE in a full-duplex mode on a unicast link; and
apply a timing advance (TA) adjustment for transmission or reception of the sidelink communication with the first UE, the TA adjustment being based on interference at the first UE or the second UE.

23. The apparatus of claim 22, wherein the unicast link is a bidirectional unicast link that includes:
a reception link for sidelink reception from the first UE, and
a transmission link for sidelink transmission to the first UE.

24. The apparatus of claim 23, wherein the memory and the at least one processor are further configured to:
perform a link quality measurement to determine a reception link quality; and
transmit, to the first UE, a measurement report including the reception link quality.

25. The apparatus of claim 23, wherein the memory and the at least one processor are further configured to:
perform a link quality measurement to determine a reception link quality; and
transmit, to the first UE, an indication of whether the reception link quality satisfies a minimum quality threshold for the reception link.

26. The apparatus of claim 23, wherein the memory and the at least one processor are further configured to:
receive a first quantity of transmissions from the first UE, the first quantity of transmissions including M transmission sets, each transmission set of the M transmission sets associated with a first set of TA candidates of the first UE, and each transmission set of the M transmission sets including N transmissions associated with a same TA candidate of the first set of TA candidates;
transmit a second quantity of transmissions to the first UE, the second quantity of transmissions including M transmission sets, each transmission set of the M transmission sets including N transmissions associated with a different TA candidate of a second set of TA candidates of the second UE; and
perform self-interference measurements for different combinations of the first set of TA candidates of the first UE and the second set of TA candidates of the second UE.

27. The apparatus of claim 26, wherein the memory and the at least one processor are further configured to:
receive a quasi co-location (QCL) relationship associated with the N transmissions of a respective transmission set from the first UE.

28. The apparatus of claim 27, wherein the QCL relationship is with respect to a timing and a spatial configuration of the N transmissions.

29. The apparatus of claim 26, wherein the memory and the at least one processor are further configured to:
receive a configuration associated with a TA adjustment from the first UE, the configuration including one or more of:
an indication of a set of time-frequency resources of transmissions associated with the TA adjustment from the first UE,
an indication of whether to transmit to the first UE using the set of time-frequency resources,
an indication of whether to transmit to the first UE using resources overlapping in a time-domain and non-overlapping in a frequency-domain, or
an indication of one or more measurements to report to the first UE.

30. A method of wireless communication with a first user equipment (UE) at a second UE, the method comprising:
transmitting and receiving sidelink communication with the first UE in a full-duplex mode on a unicast link; and
applying a timing advance (TA) adjustment for transmission or reception of the sidelink communication with the first UE, the TA adjustment being based on interference at the first UE or the second UE.
